(19) United States
(12) Patent Application Publication
(10) Pub. No.: US 2014/0236687 A1
(43) Pub. Date: Aug. 21, 2014

(54) CONTRIBUTION SYSTEM, METHOD AND DEVICE FOR INCENTIVIZING CONTRIBUTION OF INFORMATION

(71) Applicants: Godard K. Abel, Lake Forest, IL (US); Timothy W. Handorf, Trevor, WI (US); Mark F. Myers, Beach Park, IL (US); Matthew M. Gorniak, Schaumburg, IL (US); Michael Wheeler, Chicago, IL (US); Daniel S. Kaplan, Chicago, IL (US); Hamed Asghari, Rolling Meadows, IL (US)

(72) Inventors: Godard K. Abel, Lake Forest, IL (US); Timothy W. Handorf, Trevor, WI (US); Mark F. Myers, Beach Park, IL (US); Matthew M. Gorniak, Schaumburg, IL (US); Michael Wheeler, Chicago, IL (US); Daniel S. Kaplan, Chicago, IL (US); Hamed Asghari, Rolling Meadows, IL (US)

(73) Assignee: G2Labs, Inc.

(21) Appl. No.: 13/768,945

(22) Filed: Feb. 15, 2013

(51) Int. Cl. G06Q 30/02

(52) U.S. Cl. CPC G06Q 30/0218
USPC 705/14.2

(57) ABSTRACT

A system, method and device provide an incentive for the contribution of information related to marketed offerings. In one embodiment, the system has a data storage device storing data associated with marketed offerings, at least one point-earning condition and at least one award condition.

### CROSS REFERENCE TO RELATED APPLICATION

This application is related to the following commonly-owned, co-pending patent application: U.S. patent application entitled “Scoring System, Method and Device for Generating and Updating Scores for Marketed Offerings” filed on Feb. 15, 2013, having Attorney Docket No. 74.2760.P002U1.

### COPYRIGHT NOTICE

A portion of the disclosure of this patent document contains, or may contain, material which is subject to copyright protection. The copyright owner has no objection to the photocopy reproduction by anyone of the entire patent document in exactly the form it appears in the Patent and Trademark Office patent file or records, but otherwise reserves all copyrights whatsoever.

### BACKGROUND

People sometimes read product reviews before they purchase products. Certain websites provide product reviews. These reviews often include feedback from people who have purchased products. Sometimes the feedback is negative, and other times the feedback is positive. The product review information includes an overall rating based on the ratings provided by past customers. For example, the overall rating may be 8.3 out of 10.

Many of the overall ratings are not supported by an adequate number of reviews. This is because many customers do not provide reviews of the products they buy. The less reviews, the less likely that the overall rating will be helpful to potential purchasers. When an overall rating is based on a relatively small number of reviews, the overall rating can provide misleading or unreliable indications of the product strength. There is therefore a need to incentivize or otherwise encourage customers and others to provide reviews and input about products.

Another drawback is that the overall rating of the known product review websites is based only on the customers' ratings. The overall rating does not take into account additional types of data which may have a significant bearing on customer satisfaction. As a result, the overall rating can have a deficient correlation to the actual strength of a product.

Therefore, there is a need to overcome, or otherwise lessen the effects of, the challenges, drawbacks and disadvantages described above.

### SUMMARY

In one embodiment, the main system includes a contribution system and a scoring system. The contribution system incentivizes contributors to submit information related to marketed offerings, including, but not limited to, products and services. The scoring system combines the contributor-derived information with supplemental information. Based on the combined information and predetermined logic, the scoring system produces scores for the marketed offerings. Users may refer to the scores for assistance with their purchasing decisions.

The term, “user” is used herein as a reference to a person who interacts with the contribution system, scoring system or the main system generally. Some users may assume the role of a contributor, that is, one who contributes information to the contribution system. Other users may assume the role of a searcher, that is, one who uses the scoring system when researching a product, service or other marketed offering.

Depending upon the circumstances, a contributor or user of the contribution system may or may not have actually used any of the marketed offerings. For example, a contributor or user may be a past customer (i.e., a company who has previously purchased a product), a person who works, or has worked, for a past customer (i.e., an IT purchaser, IT installer, IT support staff member or employee with actual experience using the product), a technology guru, a professional in the technology review industry, a member of the press, or a writer for a journal.

In one embodiment, the contribution system includes a data storage device accessible by a processor. The data storage device stores data associated with: (a) a plurality of different marketed offerings; (b) one or more point-earning conditions; (c) one or more award conditions; and (d) one or more awards associated with the one or more award conditions.

Also, the data storage device stores a plurality of instructions readable by a processor. In accordance with the instructions, the processor receives information from a user or contributor related to at least one of the marketed offerings. The processor then determines whether the received information satisfies one of the point-earning conditions. Next, the processor establishes a point balance for the user. The point balance depends upon the determination. The processor then determines whether the point balance satisfies one of the award conditions. Next, the processor allocates one of the awards to the user in response to the point balance satisfying one of the award conditions.

In one embodiment, the scoring system includes a data storage device accessible by a processor. Depending upon the embodiment, the data storage device may be the same as the contribution system's data storage device, or the scoring system may have its own separate data storage device. In either case, the data storage device utilized by the scoring system, stores data associated with a plurality of different marketed offerings.

The data storage device also stores a plurality of contributor-derived factors. The contributor-derived factors are associated with the marketed offerings, and the contributor-derived factors are derived from a contribution data source. The contribution data source has information derived from one or more contributors. The contributor-derived factors change depending upon a change in the contribution data source.

Also, the data storage device stores a plurality of supplemental factors associated with the marketed offerings. The supplemental factors are derived from a supplemental data source. The supplemental factors change depending upon a change in the supplemental data source.

The data storage device also stores one or more mathematical formulas and a plurality of instructions which are readable by the processor. For one of the marketed offerings, in accordance with the instructions, the processor receives the contributor-derived factor associated with that marketed offering. The processor then receives the supplemental factor associated with that marketed offering. Next, the processor applies the one or more mathematical formulas to the received contributor-derived factor and the received supplemental factor. Then the processor determines a score based on the application of the one or more formulas. The processor then displays the score in association with that marketed offering.

Additional features and advantages of the present invention are described in, and will be apparent from, the following Brief Description of the Figures and Detailed Description.

### BRIEF DESCRIPTION OF THE FIGURES

FIG. 1 is a schematic block diagram illustrating one embodiment of the main system.

FIG. 2 is a schematic block diagram illustrating one embodiment of the contribution system, processor and network access device.

FIG. 3 is a table illustrating one embodiment of example marketed offerings.

FIG. 4 is a view of one example of one embodiment of a marketed offerings interface.

FIG. 5 is a view of one example of one embodiment of a referral interface.

FIG. 6 is a view of one example of one embodiment of a contributions wanted interface.

FIG. 7 is a view of one example of one embodiment of a popular marketed offerings interface.

FIG. 8 is a view of one example of one embodiment of a marketed offerings interface, illustrating the subcategories of a marketed offering.

FIG. 9 is a view of one example of one embodiment of the first part of an award interface.

FIG. 10 is a view of the second part of the award interface of

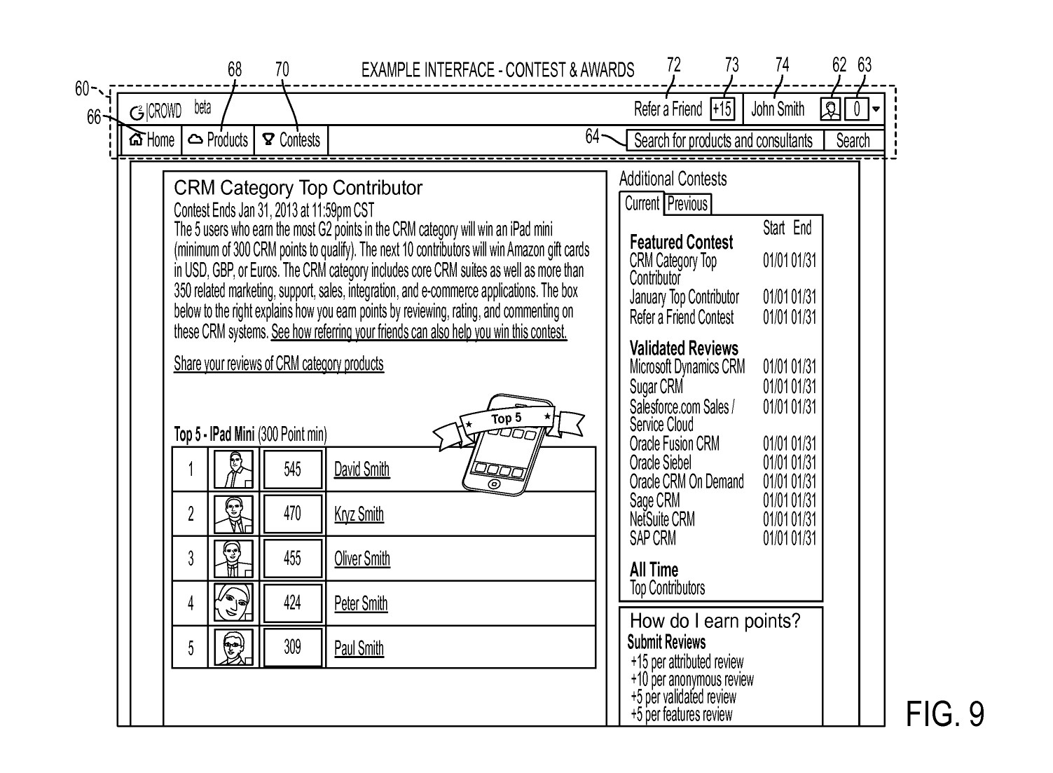

FIG. 9.

FIG. 11 is a view of one example of one embodiment of a selectable marketed offerings interface.

FIG. 12 is a view of the selectable marketed offerings interface of FIG. 11, illustrating the action options associated with one of the marketed offerings.

FIG. 13 is a view of one example of one embodiment of an abbreviated contribution collection interface.

FIG. 14 is a view of one example of one embodiment of the first part of a full contribution collection interface.

FIG. 15 is a view of the second part of the full contribution collection interface of FIG. 14.

FIG. 16 is a view of the third part of the full contribution collection interface of FIG. 14.

FIG. 17 is a view of the fourth part of the full contribution collection interface of FIG. 14.

FIG. 18 is a view of one example of one embodiment of the first part of a features contribution collection interface.

FIG. 19 is a view of the second part of the features contribution collection interface of FIG. 18.

FIG. 20 is a view of the third part of the features contribution collection interface of FIG. 18.

FIG. 21 is a view of one example of one embodiment of the first part of an interface illustrating an example contribution.

FIG. 22 is a view of the second part of the interface of FIG. 21.

FIG. 23 is a view of one example of one embodiment of an interface illustrating an example validated contribution.

FIG. 24 is a view of one example of one embodiment of the first part of an interface, illustrating an example of a contributing user's activity.

FIG. 25 is a view of one example of one embodiment of the second part of an interface, illustrating an example of a contributing user's activity.

FIG. 26 is a view of one example of one embodiment of the third part of an interface, illustrating an example of user profile details.

FIG. 27 is a view of one example of one embodiment of the fourth part of an interface, illustrating an example of a contributing user's activity.

FIG. 28 is a schematic block diagram illustrating one embodiment of the scoring system, processor and network access device.

FIG. 29 is a schematic block diagram illustrating another embodiment of the scoring system, processor and network access device.

FIG. 30 is a schematic block diagram illustrating the contributor-derived factors and supplemental factors in one embodiment of the scoring system.

FIG. 31 is a schematic block diagram illustrating, in one embodiment, the flow of data from multiple data sources to the scoring determination logic resulting in the generation of scores.

FIG. 32 is a view of one example of one embodiment of an interface illustrating a comparison link.

FIG. 33 is a view of one example of one embodiment of an interface illustrating one embodiment of a marketed offering ranking list.

FIG. 34 is a view of one example of one embodiment of an interface illustrating one embodiment of a comparison graph.

FIG. 35 is a view of one example of one embodiment of an interface illustrating another embodiment of a comparison graph.

### DETAILED DESCRIPTION

### Main System

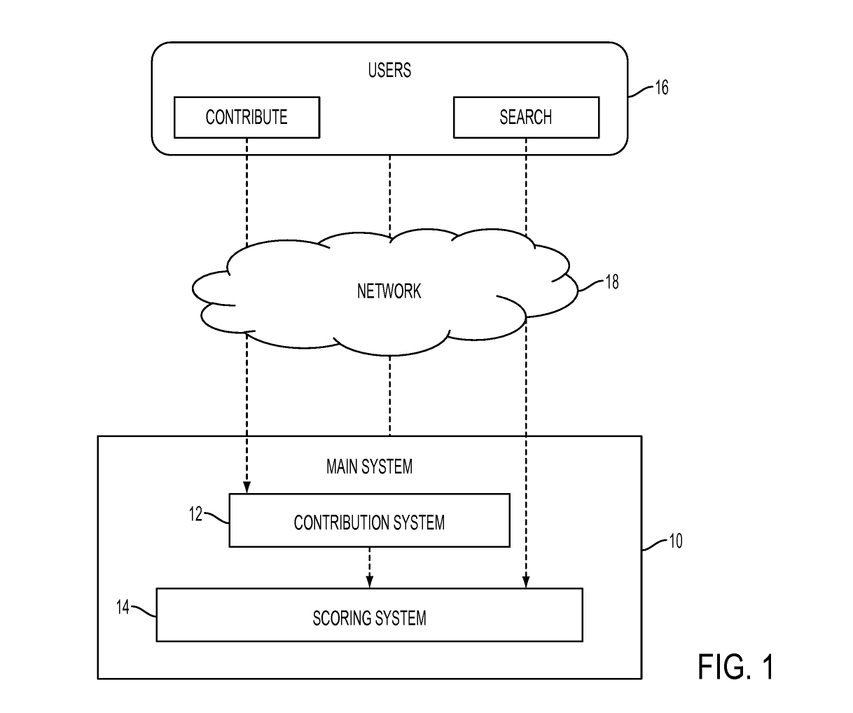

Referring to FIG. 1, in one embodiment, the main system 10 includes a contribution system 12 and a scoring system 14. Users 16 can access the main system 10 over a network 18, including, but not limited to, the Internet, a local area network, a wide area network or any other suitable data network or communication channel. In one embodiment, users 16 use network access devices to access the network 18. Depending upon the embodiment, the network access devices can include computers, smartphones or other electronic devices.

Users can access the main system 10 to provide a contribution of information related to one or more marketed offerings. Users may also search for information related to the marketed offerings. The marketed offerings can include products or services which are marketed, or are marketable, by companies, businesses, organizations, individuals or other entities.

In one embodiment, the contribution system 12 and scoring system 14 are combined, integrated and operated as a single unit. In such embodiment, the main system 10 can have a single processor and a single data storage device. In another embodiment, the contribution system 12 and scoring system 14 are separated, and separately operated, with data calls and data feeds running between the two systems.

Contribution System

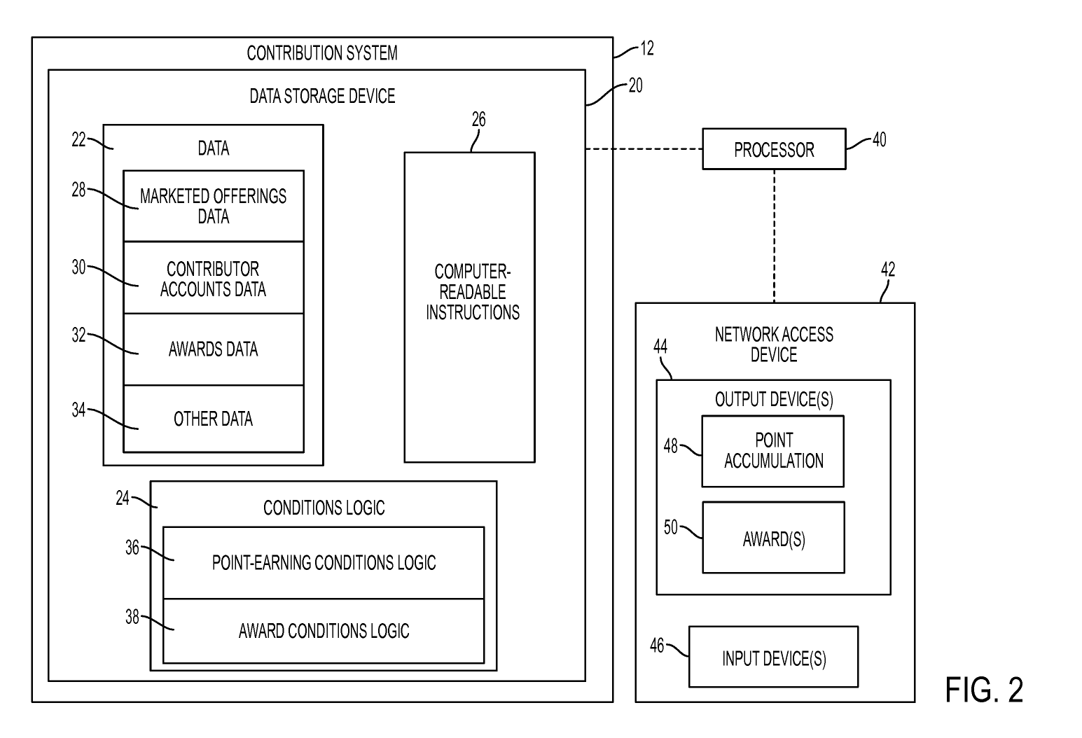

In one embodiment illustrated in FIG. 2, the contribution system 12 includes a data storage device 20. The data storage device 20 stores data 22, conditions logic 24 and computer code or computer-readable instructions 26. The data 22 includes: (a) marketed offerings data 28 related to a plurality of different types of marketed offerings, such as different brands of products or services; (b) contributor accounts data or user accounts data 30 which includes information about the separate users; (c) awards data 32 related to the awards available to the users; and (d) other data 34 related to the display and operation of the contribution system 12, including, but not limited to, Hyper-Text Markup Language (HTML) documents and forms, libraries, graphical user interface templates, image files and text.

The conditions logic 24 includes: (a) point-earning conditions logic 36 which determines the ways that users can earn points; and (b) award conditions logic 38 which determines the ways that users can receive awards. The contribution system 12 is operatively coupled to a processor 40 which, in turn, is operatively coupled to a plurality of network access devices, such as network access device 42.

Network access device 42 includes an output device 44, such as a display device. The network access device 42 also includes one or more input devices, such as input device 46. Depending upon the user's inputs to the contribution system 12, the output device 44 displays the user's point accumulation or point balance 48, and the contribution system 12 indicates any awards 50 won by the user.

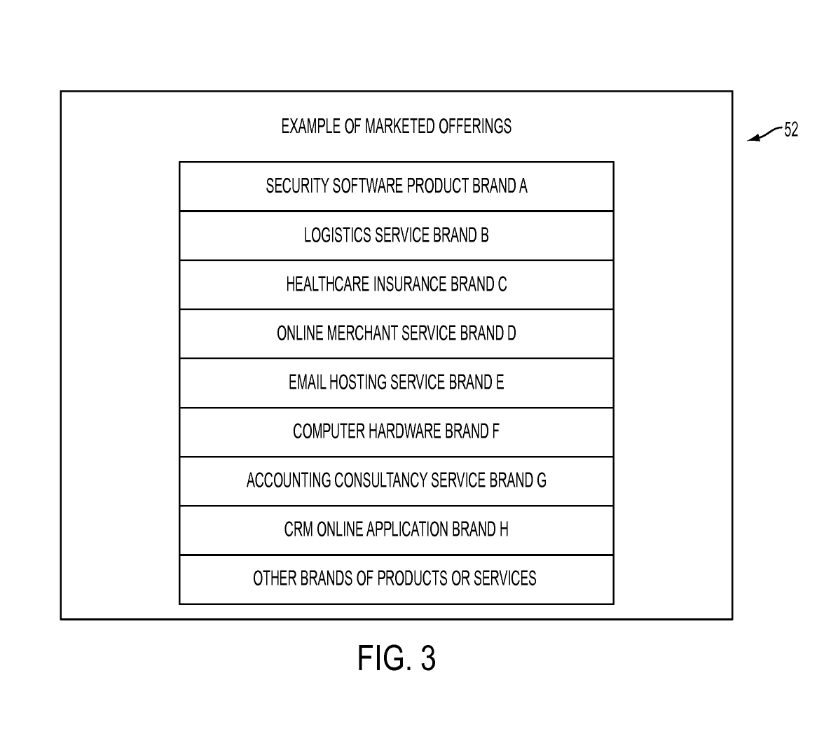

As described above, the marketed offerings 52 can include a plurality of different categories or types of products and services. For example, as shown in FIG. 3, the marketed offerings 52 can include a security software product brand A, logistics service brand B, healthcare insurance brand C, online merchant service brand D, email hosting service brand E, computer hardware brand F, accounting consultancy service brand G, Customer Relationship Management (CRM) online application brand H and other brands of products or services.

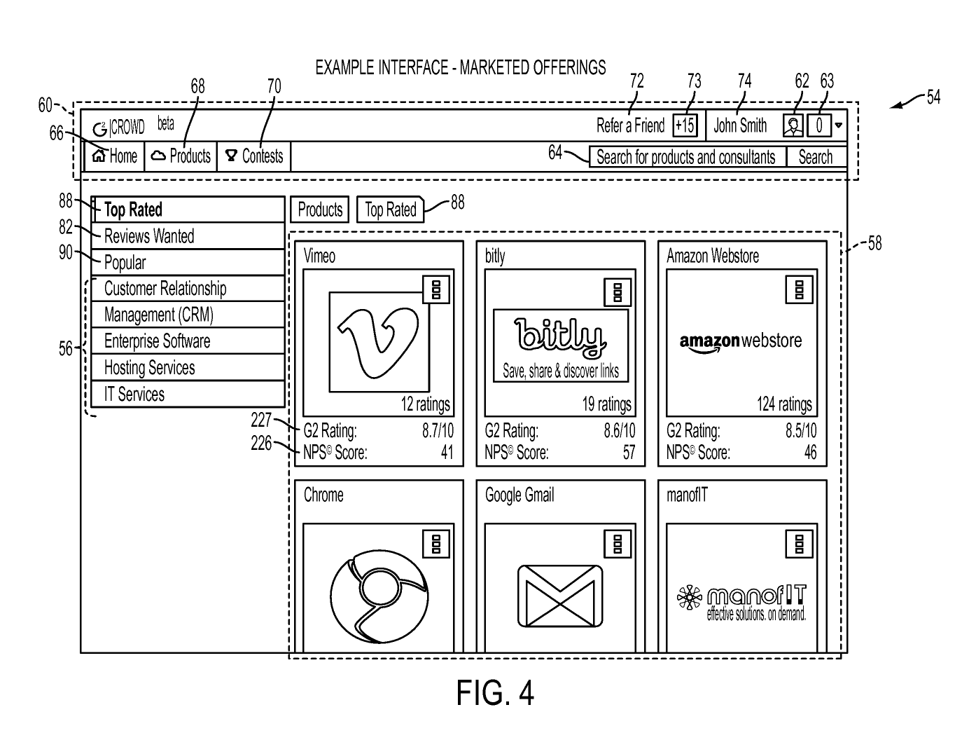

In one example illustrated in FIG. 4, the marketed offerings interface 54 displays a plurality of marketed offering categories 56, including Customer Relationship Management (CRM), Enterprise Software, Hosting Services and IT Services. The interface 54 displays a plurality of summaries 58. Each summary 58 displays a logo, icon, symbol, brand name or other identifier associated with one of the marketed offerings. Each summary 58 also displays a plurality of scores 226 and 228 which are described in detail below.

The interface 54 also includes a header 60. The header 60 displays a user photo or user image 62, the user's point accumulation or point balance 63, a search field 64 and a plurality of hyperlinks, including a Home link 66, a Products link 68, a Contests link 70, a Refer a Friend link 72, the point amount 73 provided for each referral and a user account link 74. The Home link 66, when activated, returns the user to the homepage. The Products link 68, when activated, displays the summaries 58 of the marketed offerings.

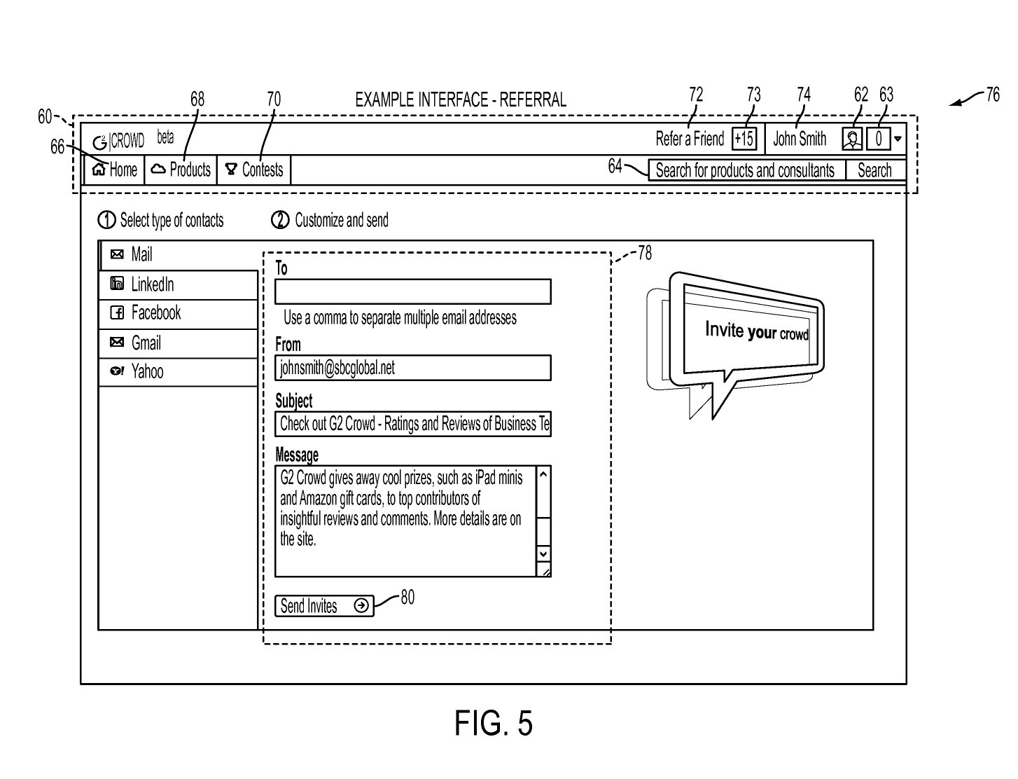

The Refer a Friend link 72, when activated, displays the referral interface 76 illustrated in FIG. 5. The referral interface 76 includes an email template 78 prepopulated with designated, customizable text, including a designated “from” email address, a designated subject description and a designated message. When the user clicks the Send Invites link 80, the processor 40 sends an electronic invitation to a personal communication account of the friend or invitee, including, but not limited to, the invitee's email address, LinkedIn identification or Facebook identification.

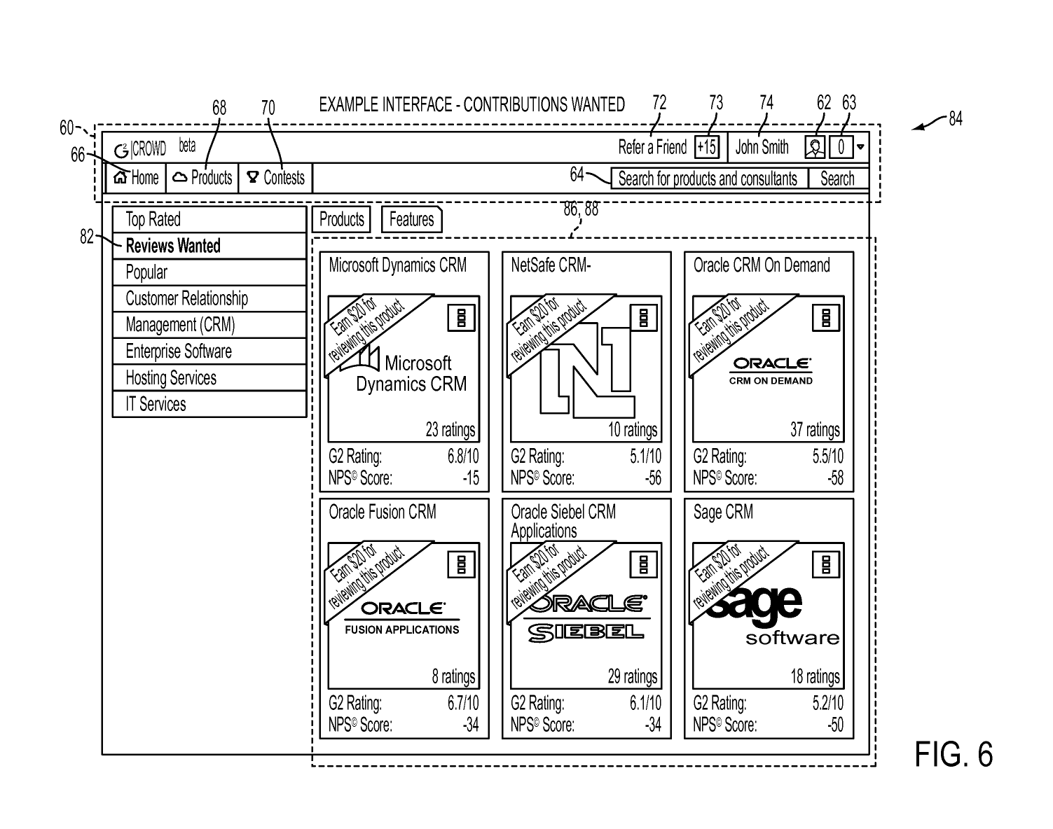

The marketed offerings interface 54 also displays a contributions wanted link 82, illustrated in FIGS. 4 and 6 as “Reviews Wanted.” When the user activates the contributions wanted link 82, the contribution system 12 displays a contributions wanted interface, such as the reviews wanted interface 84 illustrated in FIG. 6. The interface 84 displays the summaries 86 of those marketed offerings 88 which lack a designated level of contributions from users. Depending upon the embodiment, these offerings 88 may have no contributions, or they may have an amount of contributions which have not risen to the designated level. To encourage users to provide contributions, the summaries 86 display a message related to an award possibility. In the examples shown in FIG. 6, the message states, “Earn $20 for reviewing this product!”

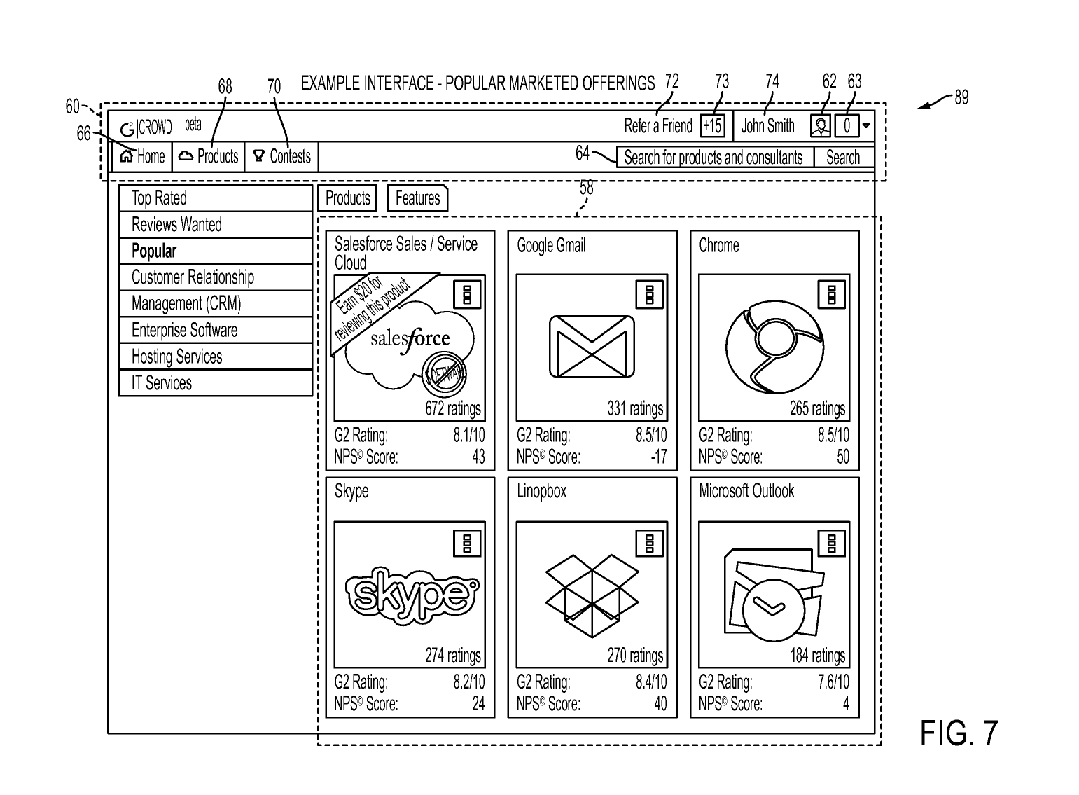

Referring back to FIGS. 4 and 6, the user can also sort the display of the marketed offerings according to score by selecting the Top Rated link 88. In the example shown in FIG. 4, the contribution system 12 displays the summaries of the marketed offerings 58 with the highest or higher scores. Alternatively, the user can sort the display of the marketed offerings according to popularity by selecting the Popular link 90. In the example interface 89 shown in FIG. 7, the contribution system 12 displays the summaries of the marketed offerings 58 with the highest or higher popularity.

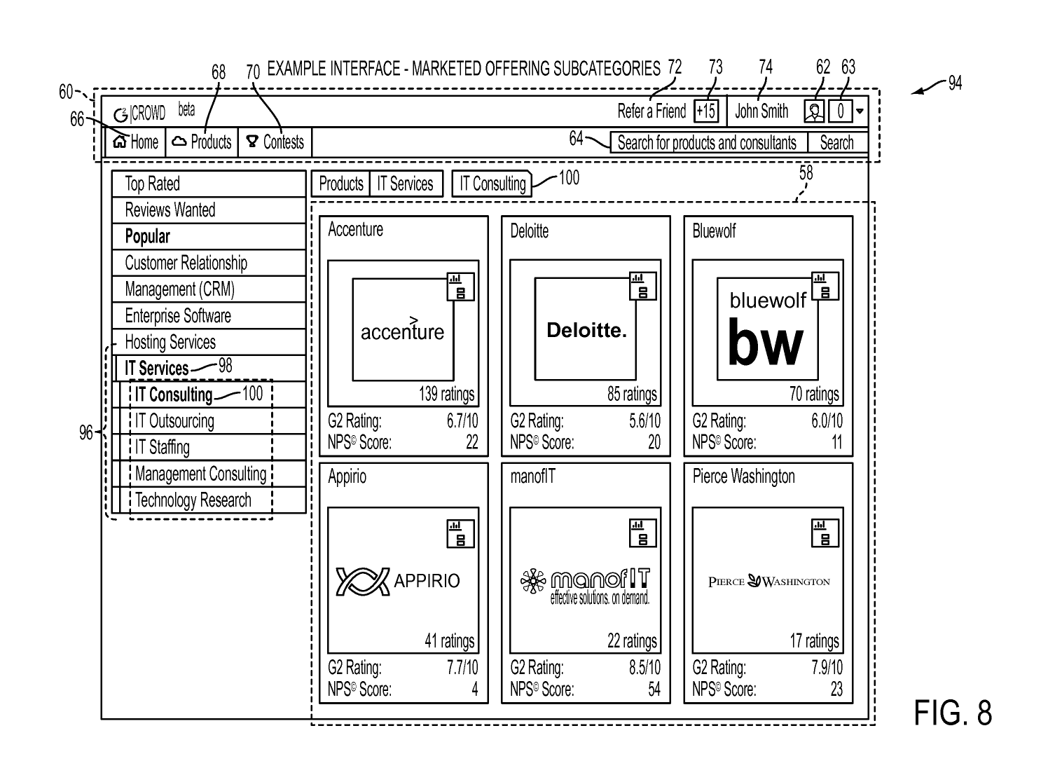

In one embodiment, for at least one of the marketed offering categories 56, the contribution system 12 displays a plurality of marketed offering subcategories. In the example illustrated in FIG. 8, the interface 94 includes a graphical, expandable menu 96. The menu 96 displays the IT Services category 98 and the following subcategories of the IT Services category 98: IT Consulting, IT Outsourcing, IT Staffing, Management Consulting and Technology Research. In the example shown, the user selected IT Consulting 100. In response, the contribution system 12 displayed the summaries of the marketed offerings 58 of that subcategory 100.

The point-earning conditions logic 36, illustrated in FIG. 2, enables a user to earn points in a variety of different ways. The following Table A sets forth the point-earning type, point-earning category and point amount associated with a plurality of different point-earning conditions:

TABLE A

| Point-Earning | Point-Earning | Point-Earning | Point |
|---|---|---|---|
| Type | Category | Condition | Amount |
| Base | Full Attributed | The contributing user's contribution | +15 |
| | Contribution | reveals his/her identity (i.e., photo | |
| | | or name), and the contribution | |
| | | includes: (a) a grade value | |
| | | selected from a scale of | |
| | | recommendation grade values; and | |
| | | (b) textual input or text entry. | |
| Bonus | Validation | The contributing user has | +5 |
| | | purchased or actually used the | |
| | | marketed offering, and the | |
| | | contributing user validates his/her | |
| | | contribution through evidence. | |
| Bonus | Features | The contribution includes a review | +5 |
| | | of the features of the marketed | |
| | | offering. | |
| Bonus | Positive Mark | Another user indicates that the | +3 |
| | | contribution of the contributing user | |
| | | is helpful. | |
| Bonus | Negative Mark | Another user indicates that the | −1 |
| | | contribution of the contributing user | |
| | | is unhelpful. | |
| Base | Full Anonymous | The contribution conceals the | +10 |
| | Contribution | contributing user's identity, and the | |
| | | contribution includes: (a) a grade | |
| | | value selected from a scale of | |
| | | recommendation grade values; and | |
| | | (b) textual input or text entry. | |
| Bonus | Validation | The contributing user has | +5 |
| | | purchased or actually used the | |
| | | marketed offering, and the | |
| | | contributing user validates his/her | |
| | | contribution through evidence. | |
| Bonus | Features | The contribution includes a review | +5 |
| | | of the features of the marketed | |
| | | offering. | |
| Bonus | Positive Mark | Another user indicates that the | +3 |
| | | contribution of the contributing user | |
| | | is helpful. | |
| Bonus | Negative Mark | Another user indicates that the | −1 |
| | | contribution of the contributing user | |
| | | is unhelpful. | |
| Base | Abbreviated | The contribution conceals the | +1 |
| | Contribution | contributing user's identity, and the | |
| | | contribution is limited to a grade | |
| | | value selected from a scale of | |
| | | recommendation grade values. | |
| Base | Attributed | A user reveals his/her identity (i.e., | +2 |
| | Comment | photo or name) and provides a | |
| | | comment about another user's | |
| | | contribution. | |
| Bonus | Positive Mark | Another user indicates that the | +2 |
| | | comment is helpful. | |
| Bonus | Negative Mark | Another user indicates that the | −1 |
| | | comment is unhelpful. | |
| Base | Anonymous | User conceals his/her identity and | +2 |
| | Comment | provides a comment about another | |
| | | user's contribution. | |
| Bonus | Positive Mark | Another user indicates that the | +2 |
| | | comment is helpful. | |
| Bonus | Negative Mark | Another user indicates that the | −1 |
| | | comment is unhelpful. | |
| Base | Referral | An existing user sends a | +15 |
| | | registration link to another person, | |
| | | and the person registers as a new | |
| | | user using the registration link | |
| | | provided by the existing user. | |
| Bonus | Referral's | A new user, referred by an existing | +3 |
| | Contribution | user, provides a contribution. | |

As provided in Table A, the point-earning types include a base and a bonus. If the user qualifies for a base, the related bonus modifies the user's point balance. In this way, a bonus can increase the user's point balance, or a bonus can decrease the user's point balance. For example, if a user's contribution reveals the user's identity (i.e., his/her photo or name) the user is allocated 15 points as the base. If the user then receives a negative mark, the user loses 1 point and has a point balance of 14 points.

In one embodiment, to qualify for the validation bonus, the user must satisfy the following criteria: (a) the contribution must include a grade or feedback regarding the features of the marketed offering; (b) the user must not have three more unhelpful than helpful marks or votes from other users; (c) the contribution must include authentic analysis based on the user's actual experience with the marketed offering; and (d) the user's evidence in support of the validation must include a screenshot demonstrating the user's actual usage of the marketed offering.

The contribution system 12 includes a plurality of point-earning restrictions which apply to Table A set forth above. In one embodiment, the point-earning restrictions are as follows:
Only a user's first one hundred contributions qualify for earning points.
Only a user's first twenty-five comments per day qualify for earning points.
Only a user's first fifty abbreviated contributions qualify for earning points.
Any review or comment which has three or more unhelpful than helpful marks, does not qualify for earning points.
A user may not vote another user's contribution as helpful and unhelpful more than ten times per month.

It should be understood that the conditions, point amounts and other data provided in Table A, as well as the point-earning restrictions described above, are examples of one embodiment of the point-earning conditions logic 36. Other conditions and point amounts can be implemented.

In one embodiment, the contribution system 12 has a plurality of different expertise or credential levels corresponding to different titles. The contribution system 12 also includes different performance conditions associated with the credential levels. In one example, the junior credential level corresponds to the “Junior Reviewer” title, and the senior credential level corresponds to the “Senior Reviewer” title. A user satisfies a junior performance condition when the user submits his/her first ten full attributed contributions. A user satisfies a senior performance condition when the user submits his/her first fifty full attributed contributions. In this example, user John Smith satisfies the senior performance condition. Consequently, the contribution system 12 displays the Senior Reviewer status or title next to John Smith's name, which is visible to other users of the main system 10.

The award conditions logic 38, illustrated in FIG. 2, enables a user to receive awards in a variety of different ways. The following Table B sets forth the award type and award associated with a plurality of different award conditions:

TABLE B

| Award Type | Award Condition | Award |
|---|---|---|
| Category- | A user must satisfy all of the | Computer |
| Specific | following criteria during a | Brand X |
| | designated contest period: (a) | |
| | he/she earns 300 points in a | |
| | designated marketed offering | |
| | category (i.e., Customer | |
| | Relationship Management); and (b) | |
| | he/she is one of the top five users | |
| | with the most points within the | |
| | designated category. | |
| Category- | A user must satisfy the following | Chance to win |
| Specific | criteria during the designated | a Computer |
| | contest period: he/she is one of the | Brand X based |
| | next fifteen users with the most | on a random |
| | points within the designated | determination |
| | category, excluding the top five | with a 1 in 15 |
| | users. | chance of winning. |
| All | A user must satisfy all of the | $100 Store |
| Categories | following criteria during a | Y Gift |
| | designated contest period: (a) | Certificate |
| | he/she earns 500 points across all | |
| | marketed offering categories; and | |
| | (b) he/she is one of the top three | |
| | users with the most points across | |
| | all marketed offering categories. | |
| All | A user must satisfy the following | $50 Store |
| Categories | criteria during the designated | Y Gift |
| | contest period: he/she is one of the | Certificate |
| | next ten users with the most points | |
| | across all categories, excluding the | |
| | top three users. | |
| Referral | A user must satisfy all of the | $100 Store |
| | following criteria during a | Y Gift |
| | designated contest period: (a) | Certificate |
| | he/she refers at least ten others | |
| | who register as new users; (b) | |
| | he/she submits at least one full | |
| | validated contribution; (c) he/she is | |
| | one of the top five users with the | |
| | most points earned based on | |
| | referral across all marketed | |
| | offering categories. | |
| Validated | A user must satisfy all of the | $20 Store |
| Full | following criteria during a | Y Gift |
| Contribution | designated contest period: he/she | Certificate |
| | is one of the first ten users to | |
| | submit a full contribution for a | |
| | designated marketed offering. | |

Some of the award conditions are based on points. Other award conditions, such as the validated full contribution, are based on events instead of points. It should be understood that the conditions, amounts and other data provided in Table B are examples of one embodiment of the point-earning conditions logic 36. Other conditions and awards can be implemented. For example, in other embodiments, the awards include one or more of the following: (a) frequent flyer points creditable toward airfare; (b) coupons; (c) fully or partially prepaid vacations; (d) magazine subscriptions; (e) fully or partially prepaid tuition for classes, certifications programs or workshops; (f) tickets to events, including, but limited to, movies, theater plays, sports games, musical performances; (g) full or partial, paid memberships to fitness clubs or other establishments; or (h) discounted or paid subscriptions for services provided by the implementor of the main system 10.

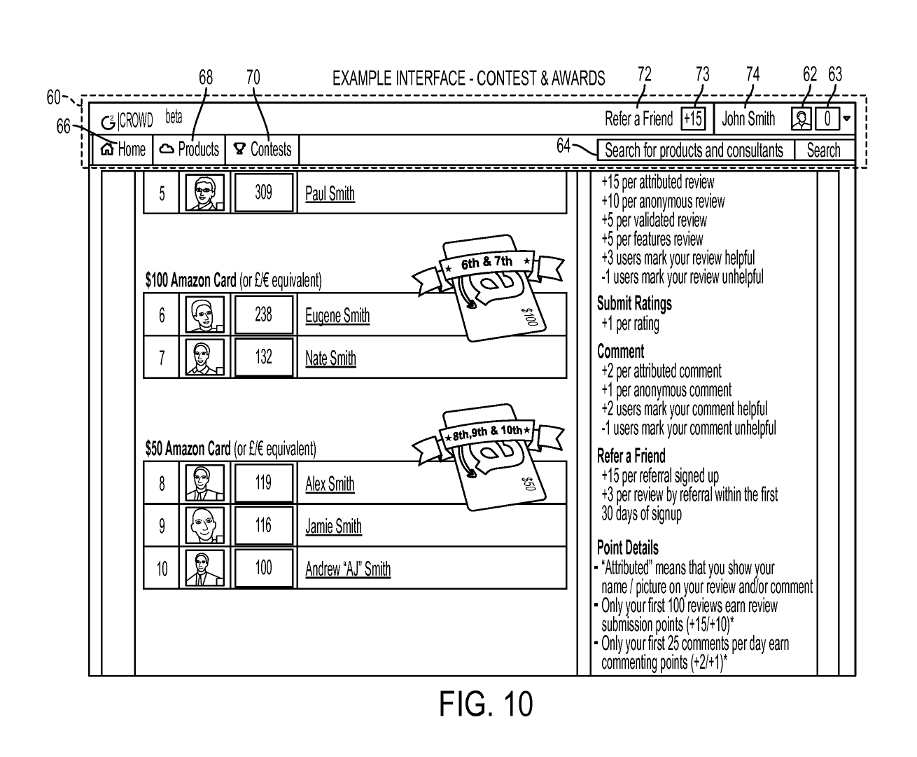

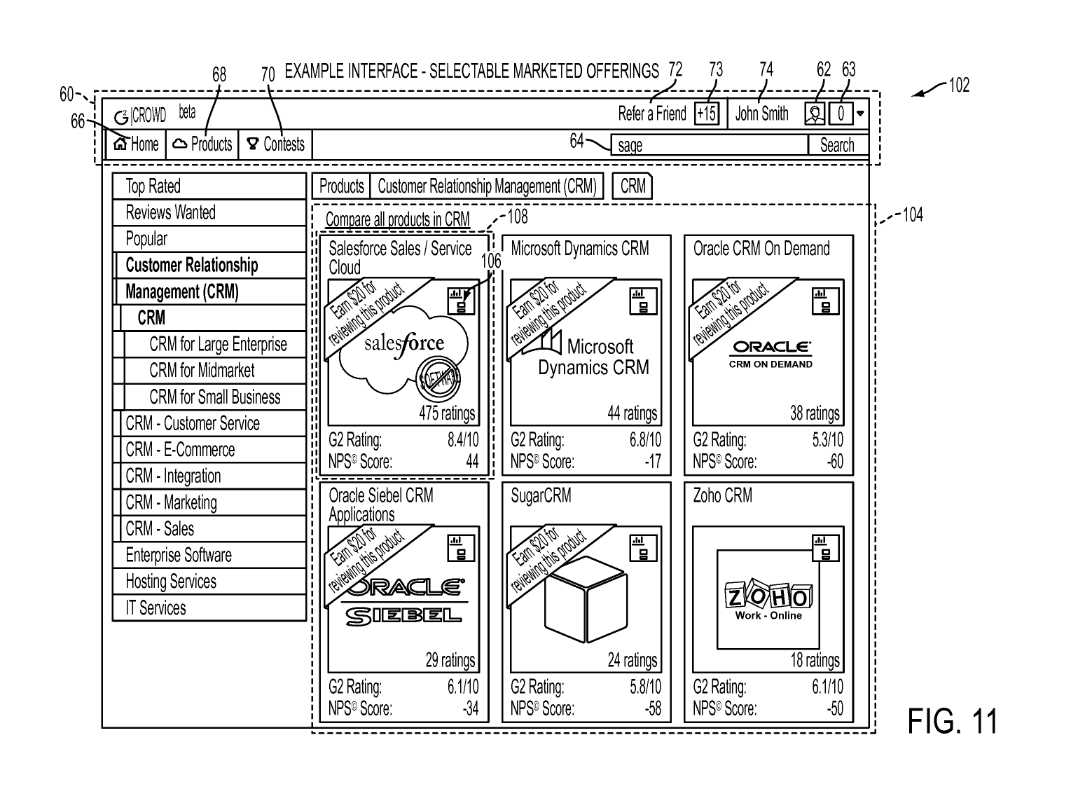

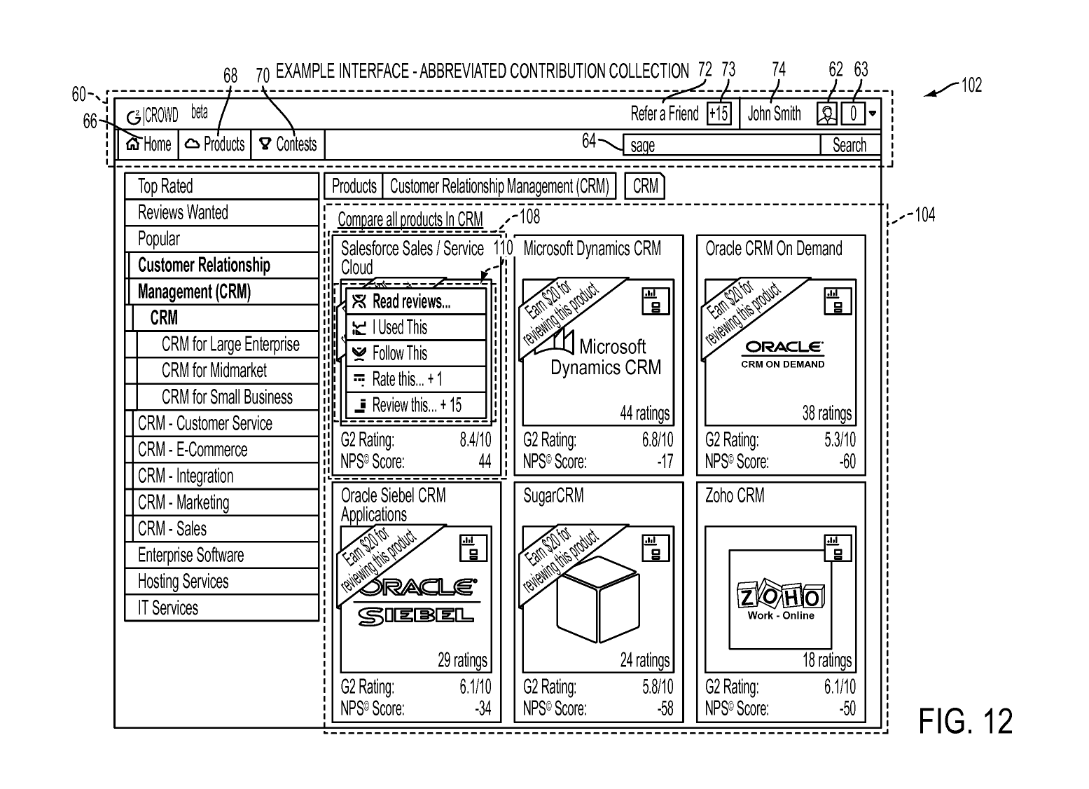

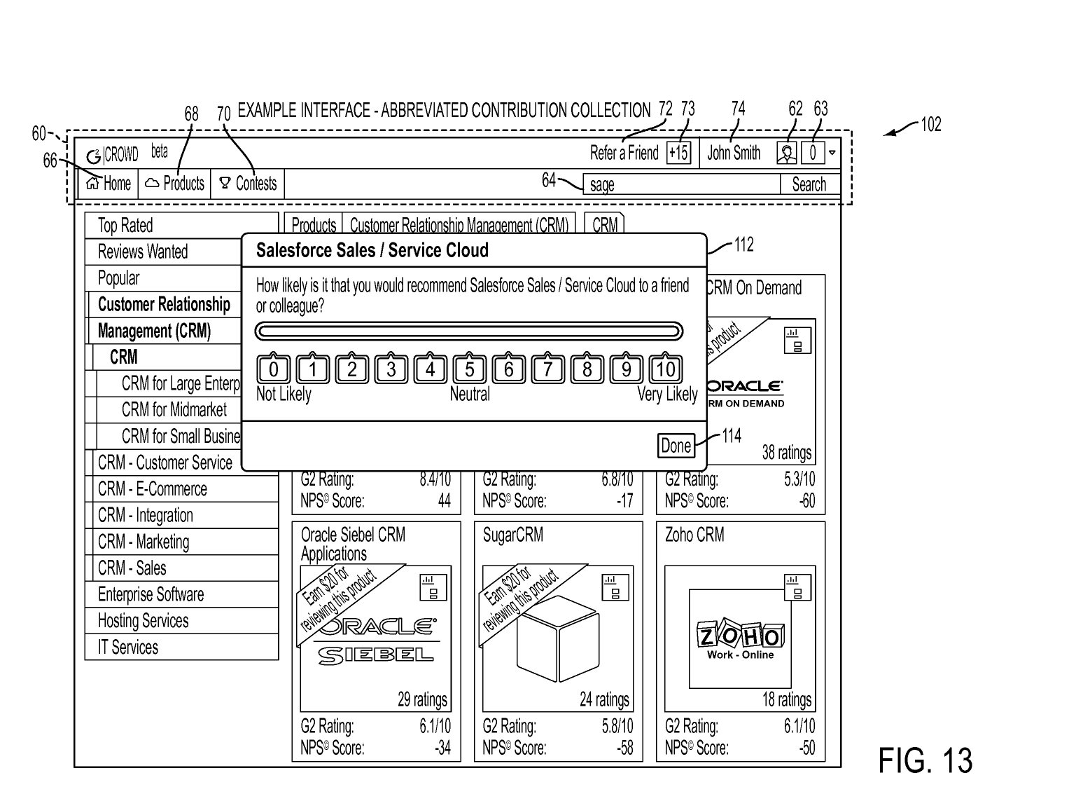

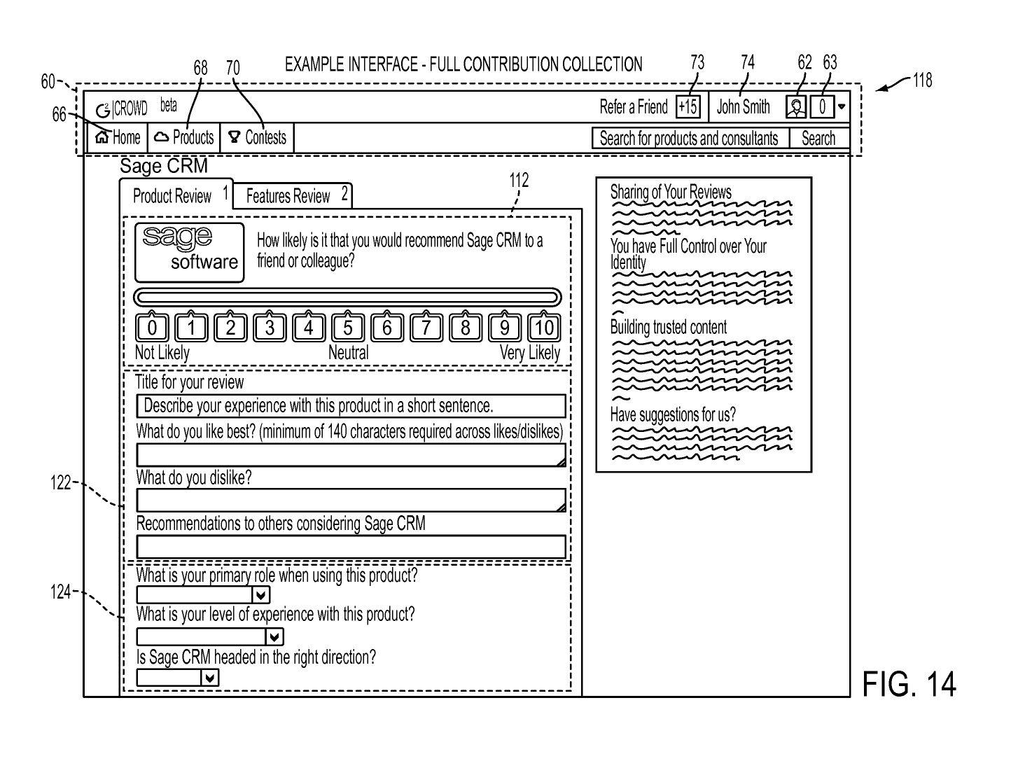

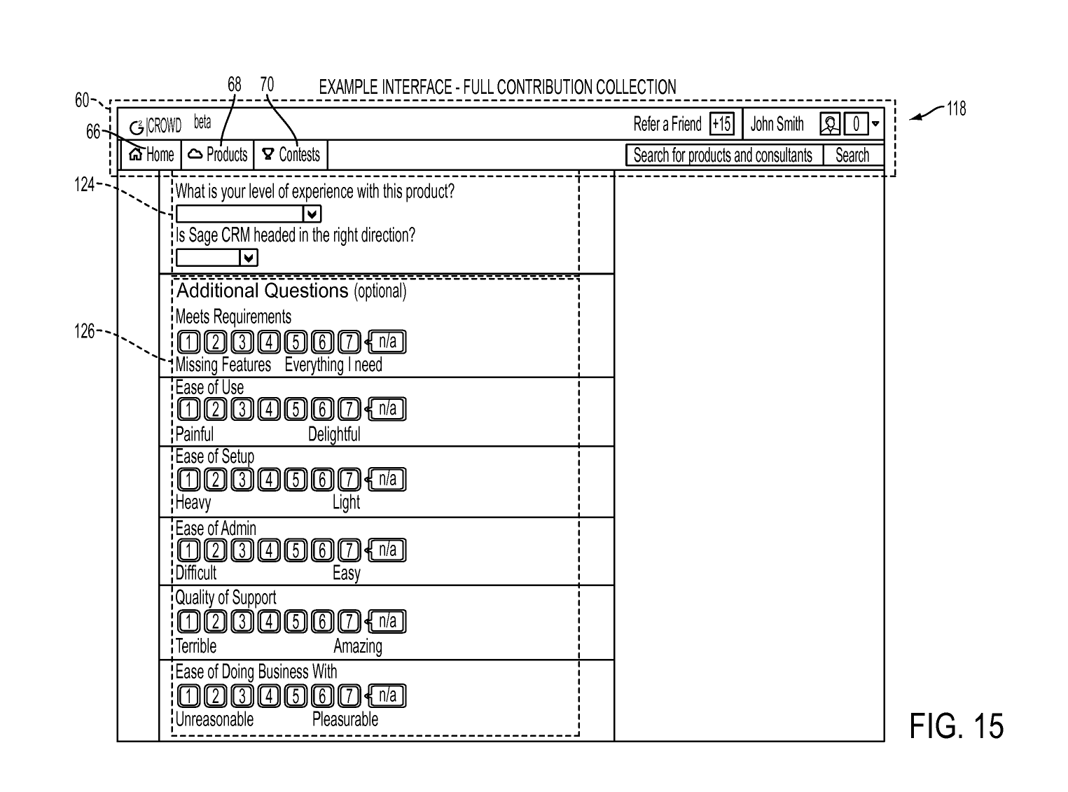

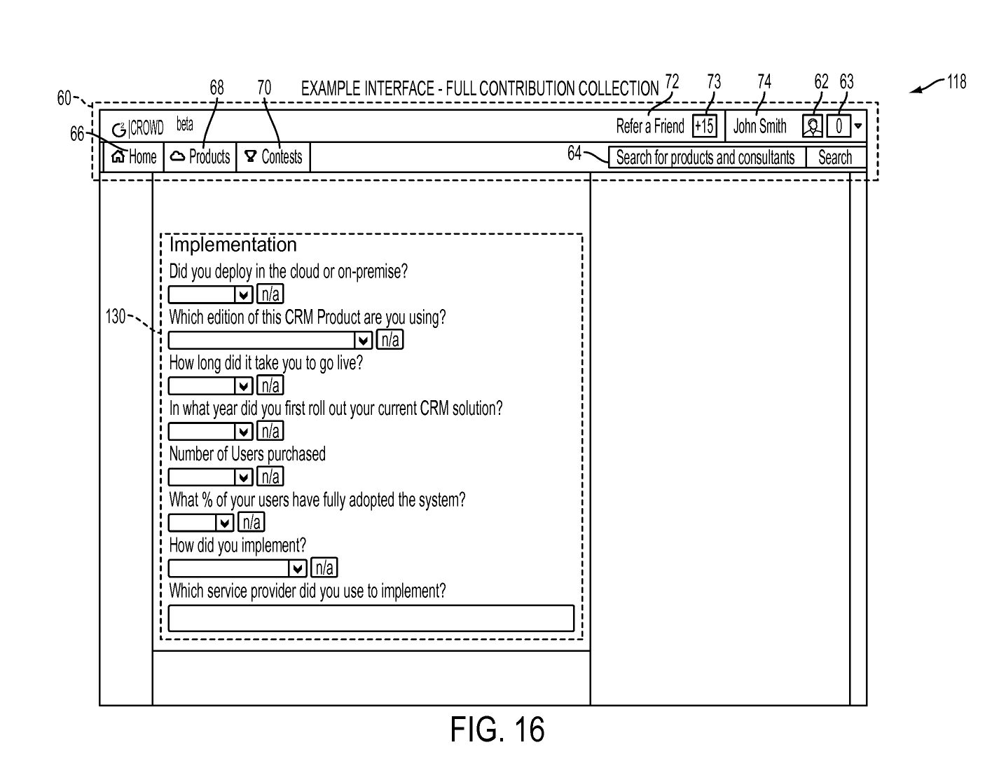

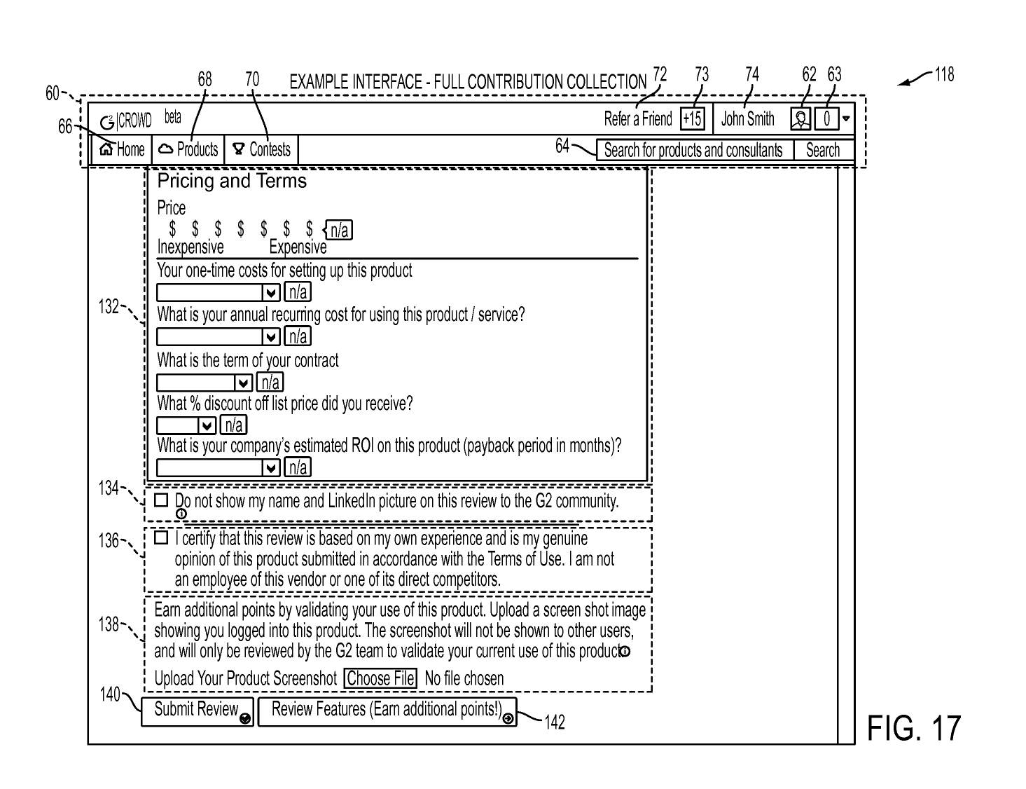

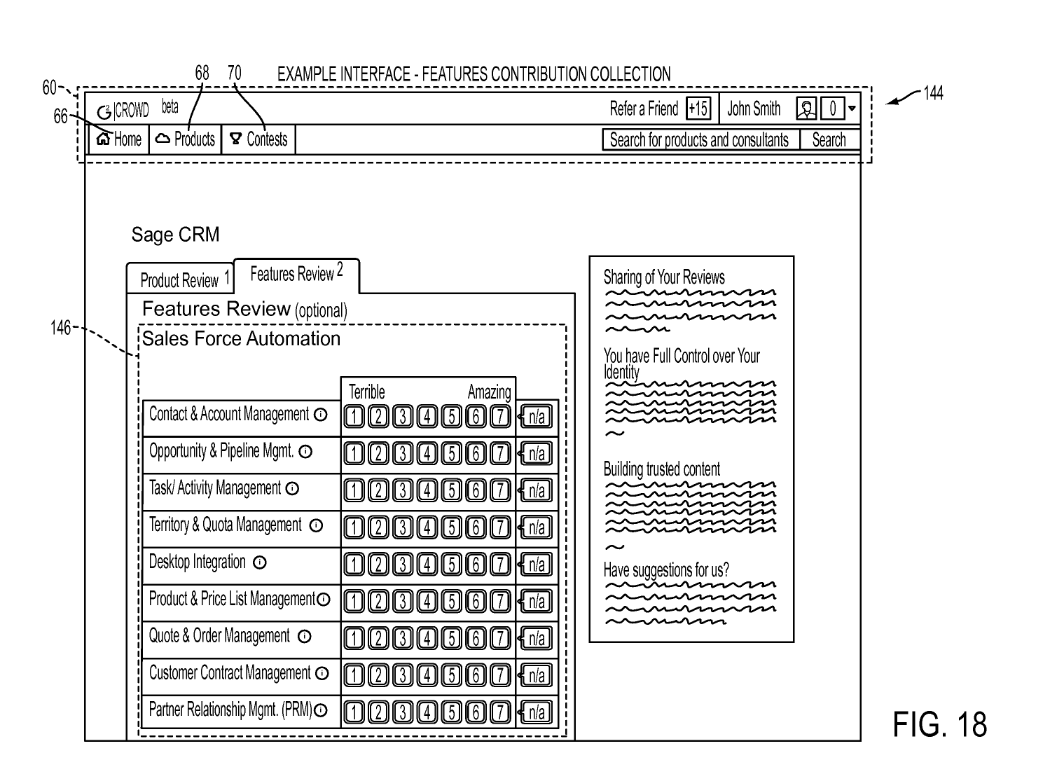

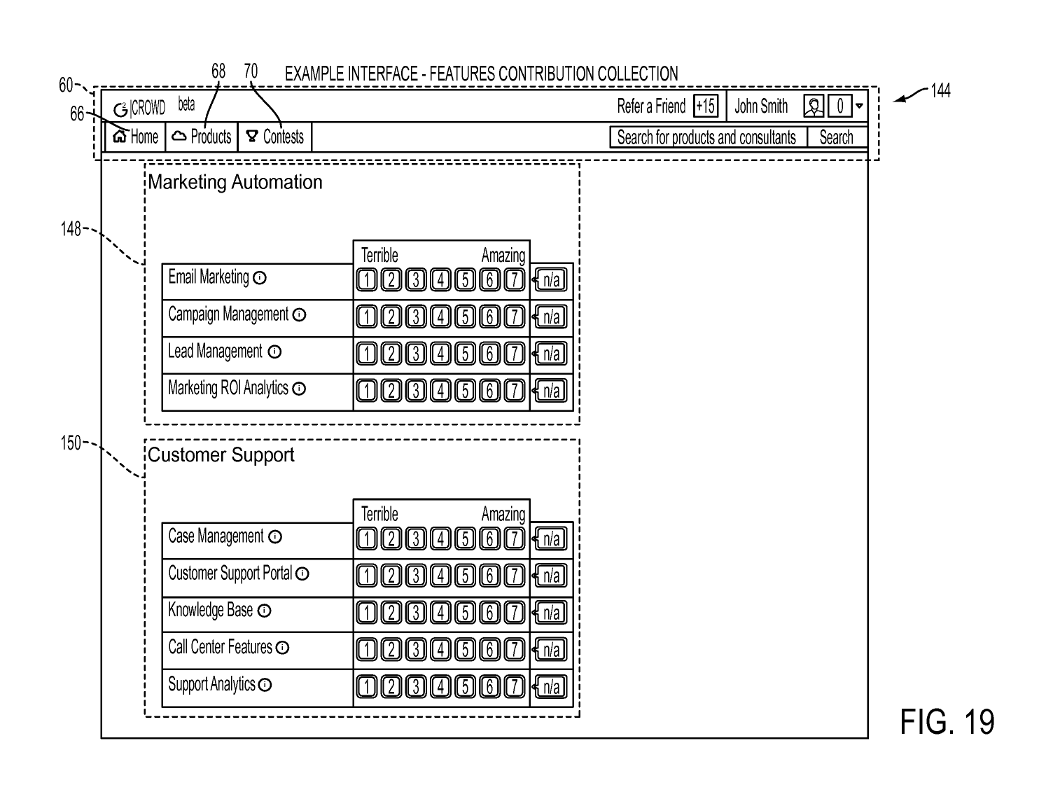

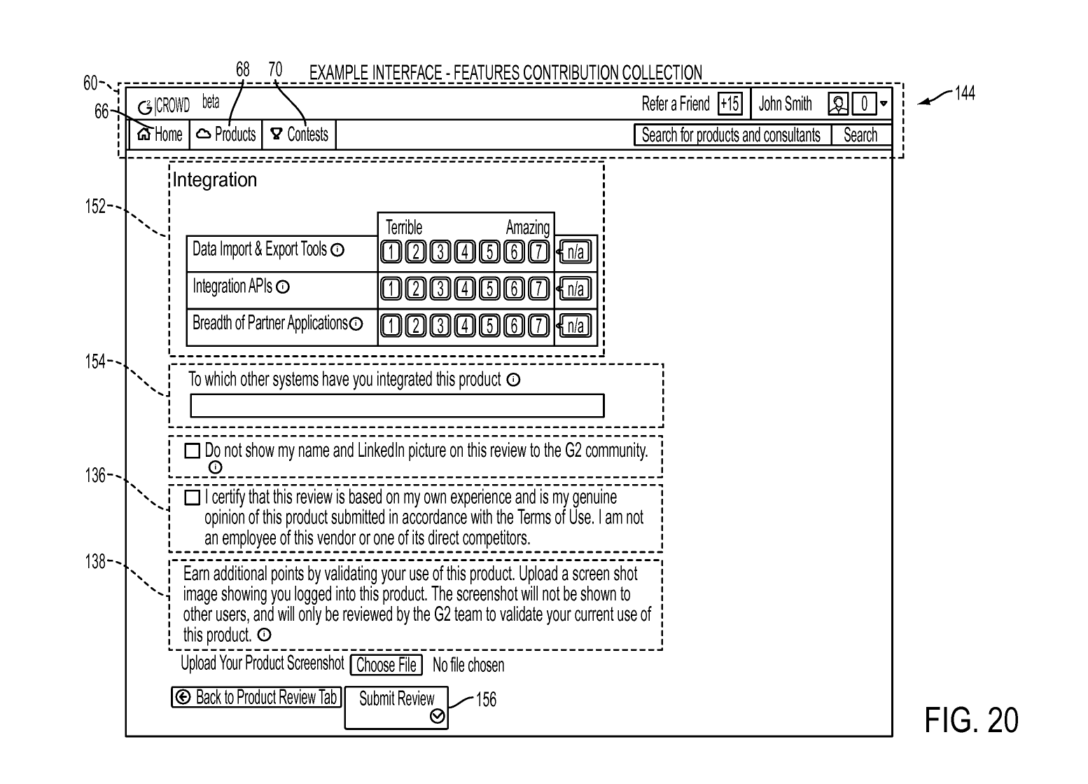

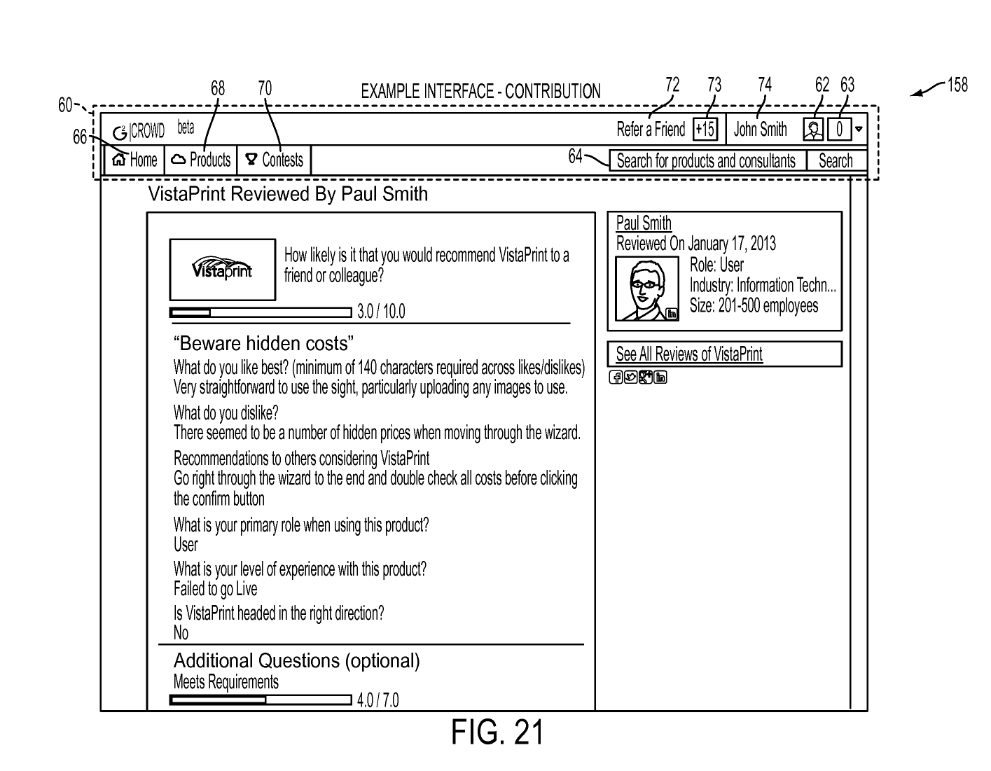

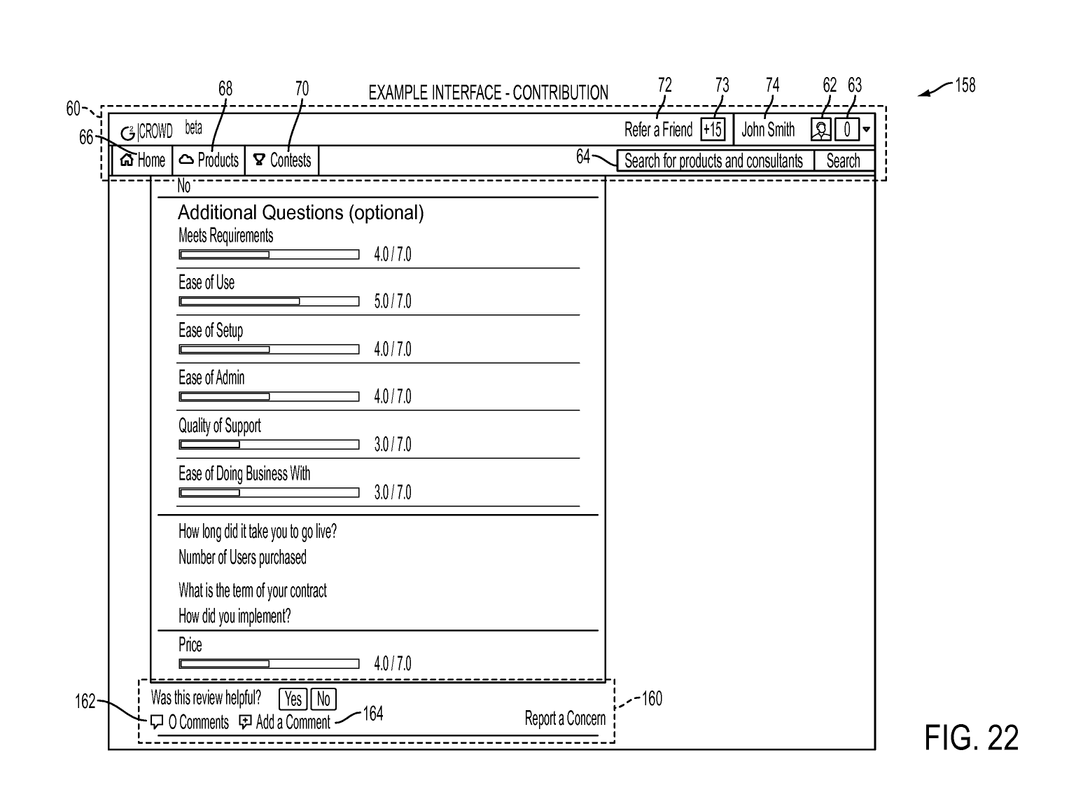

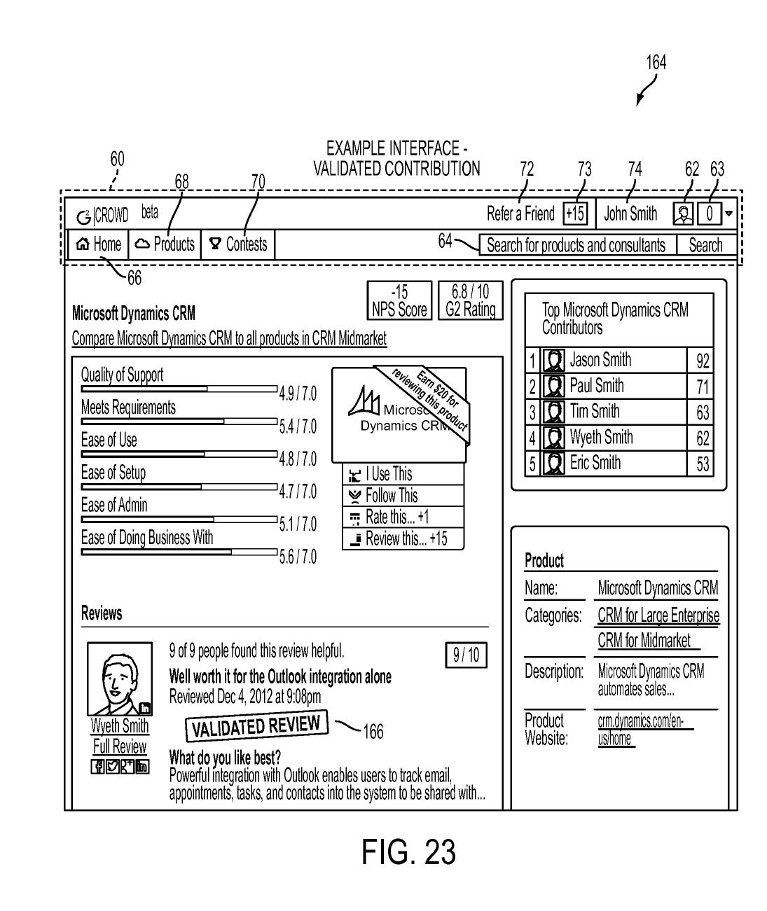

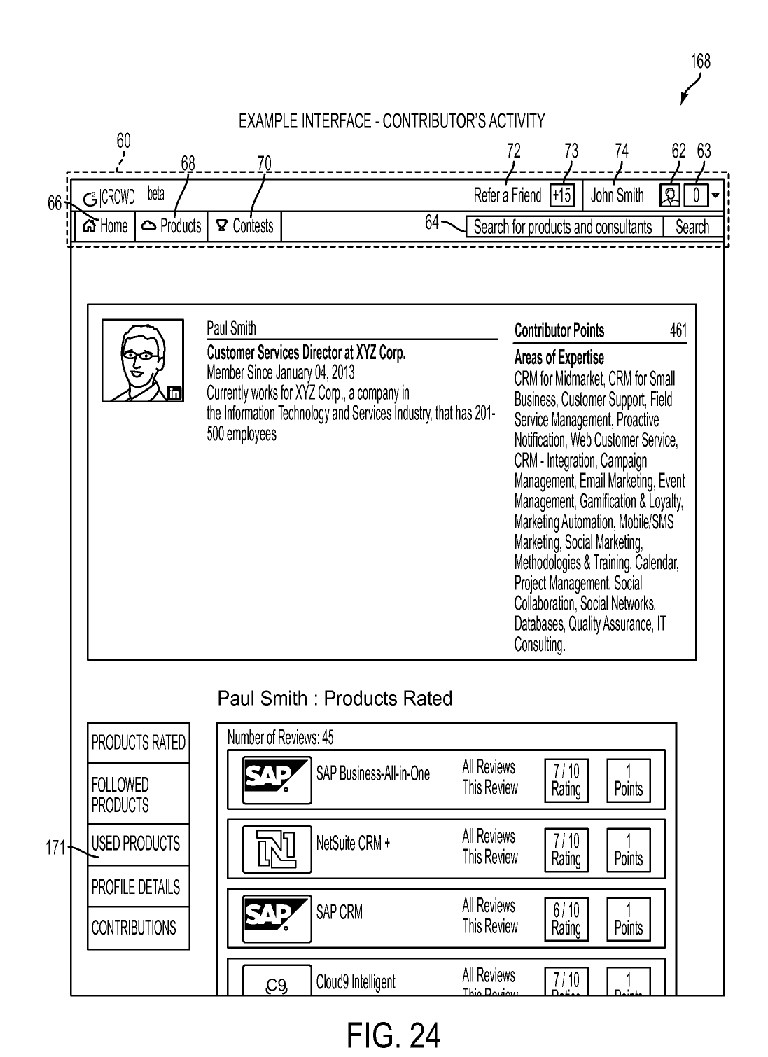

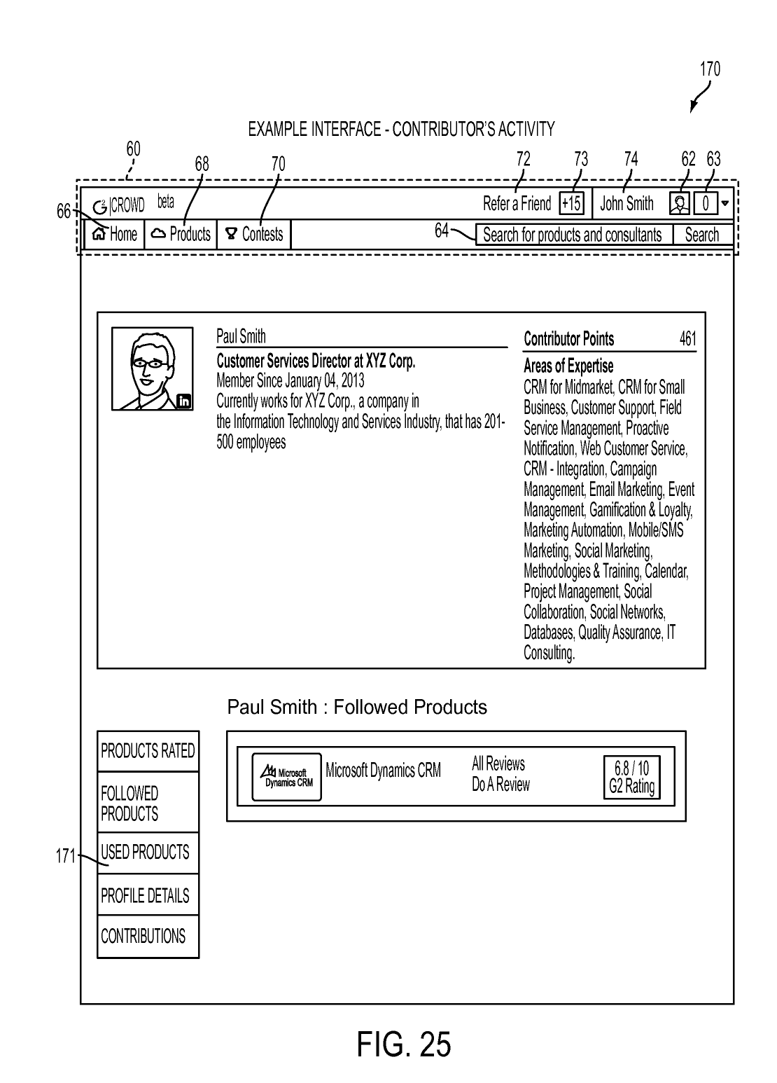

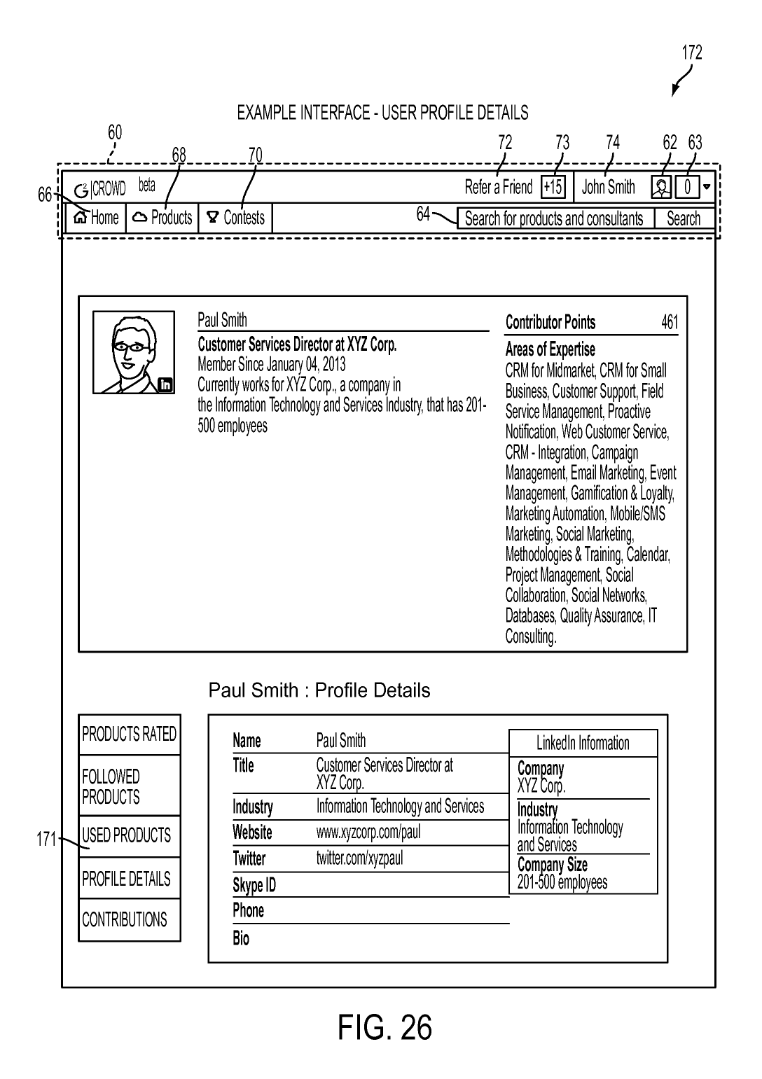

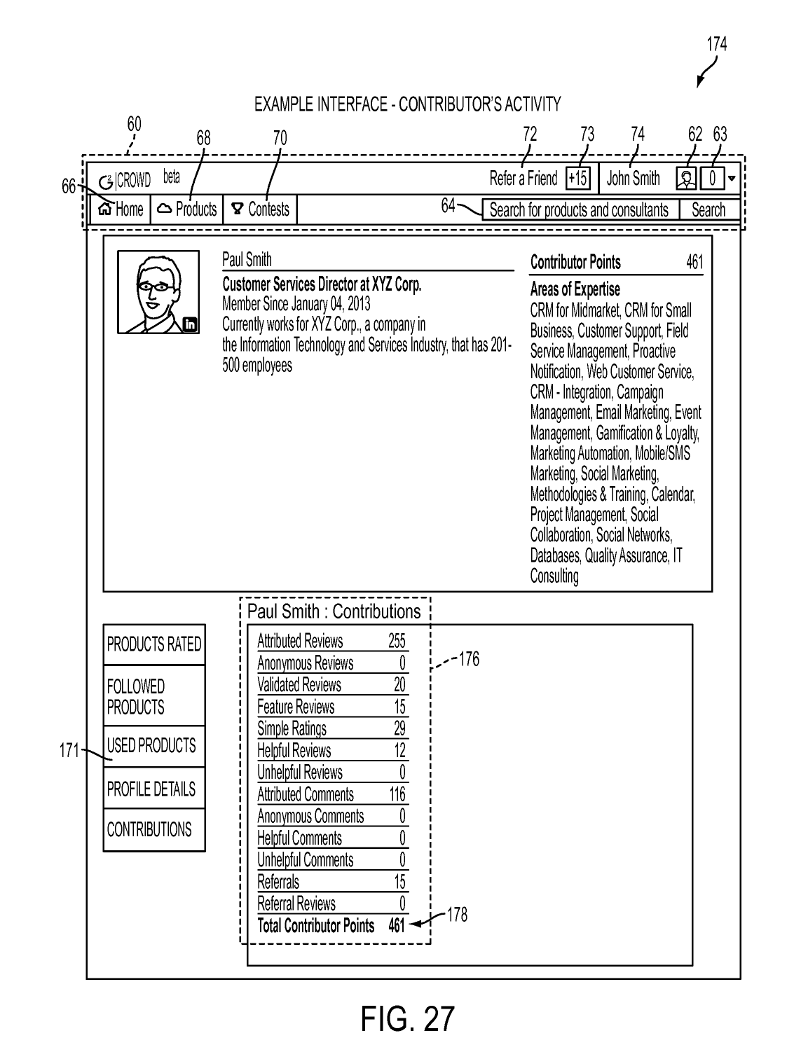

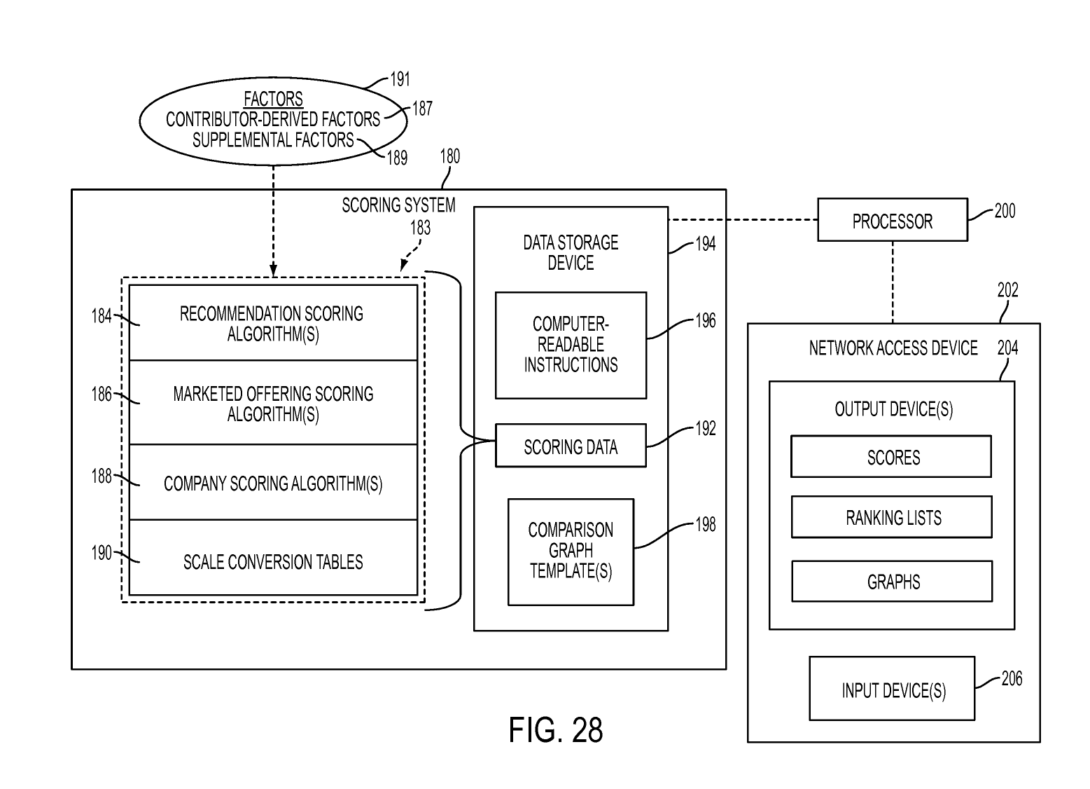

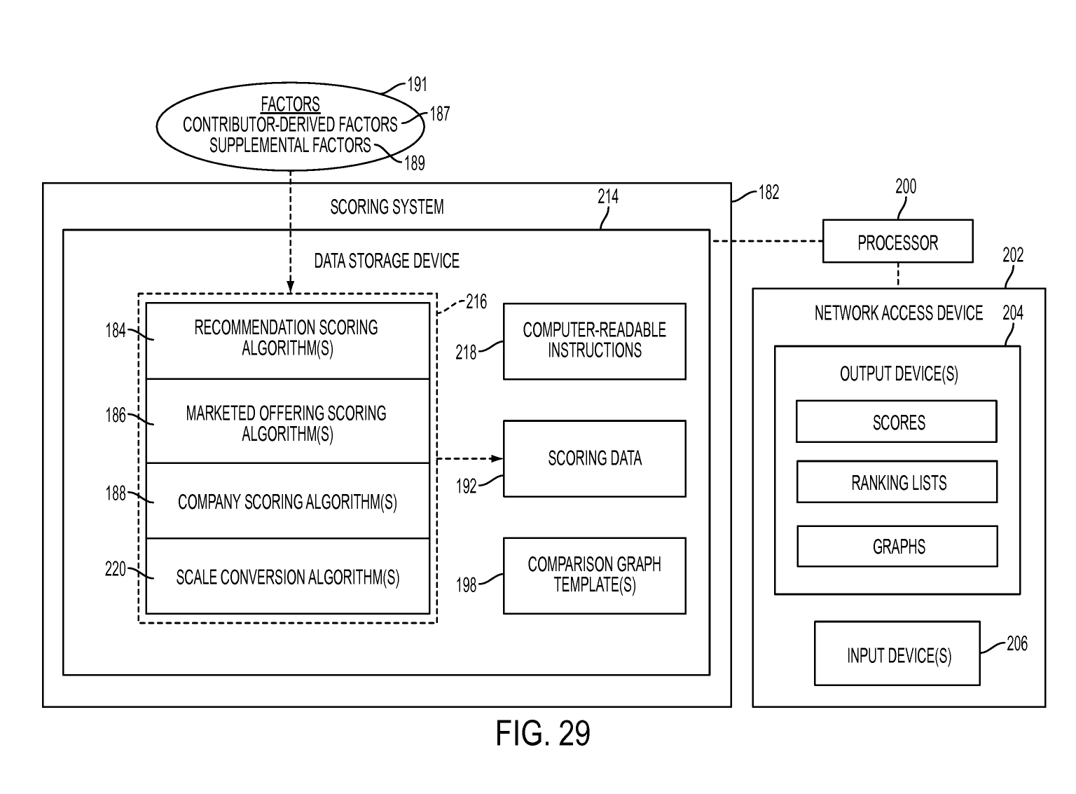

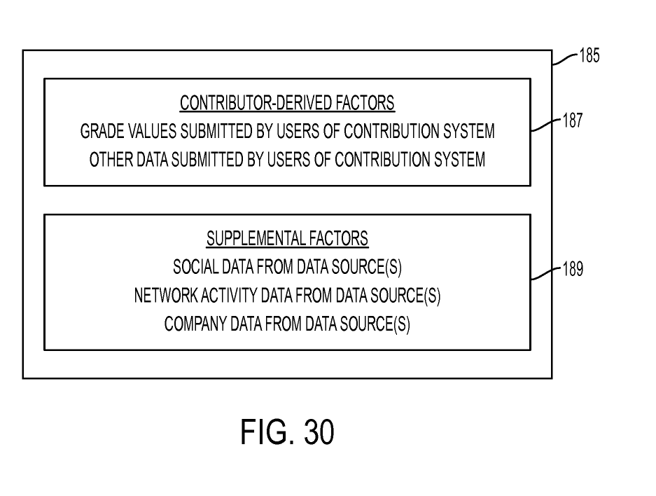

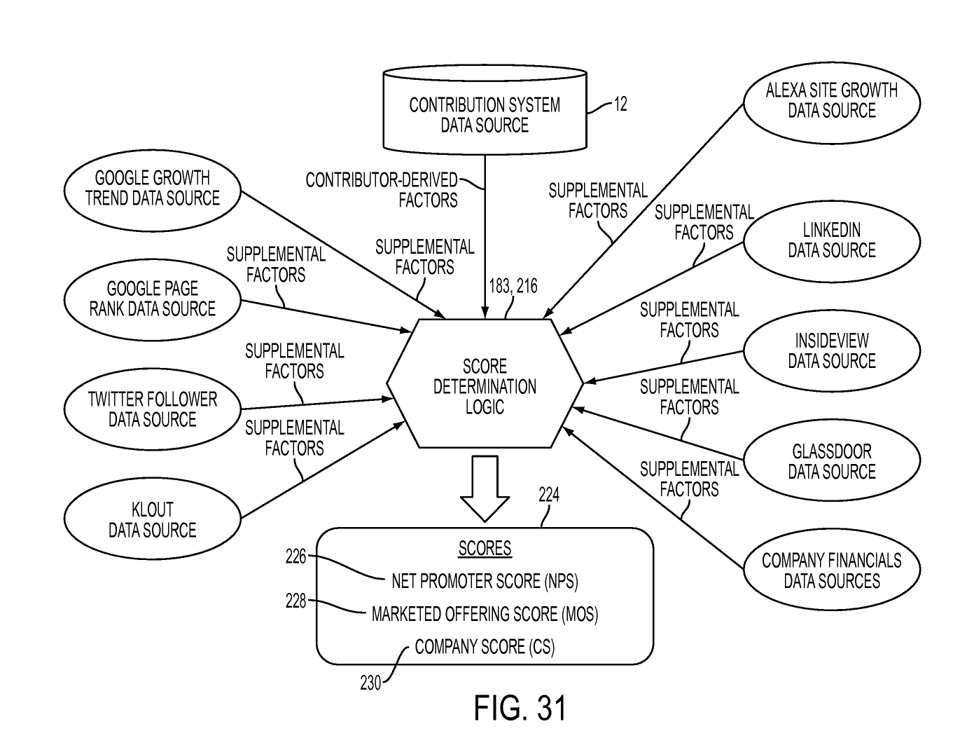

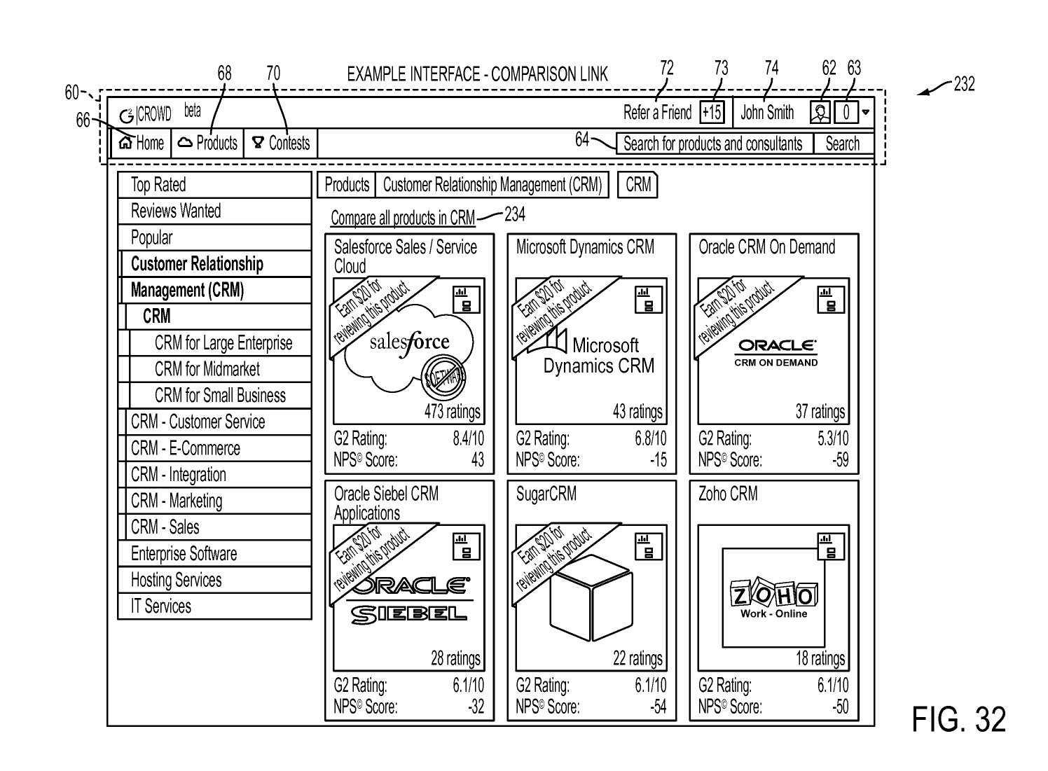

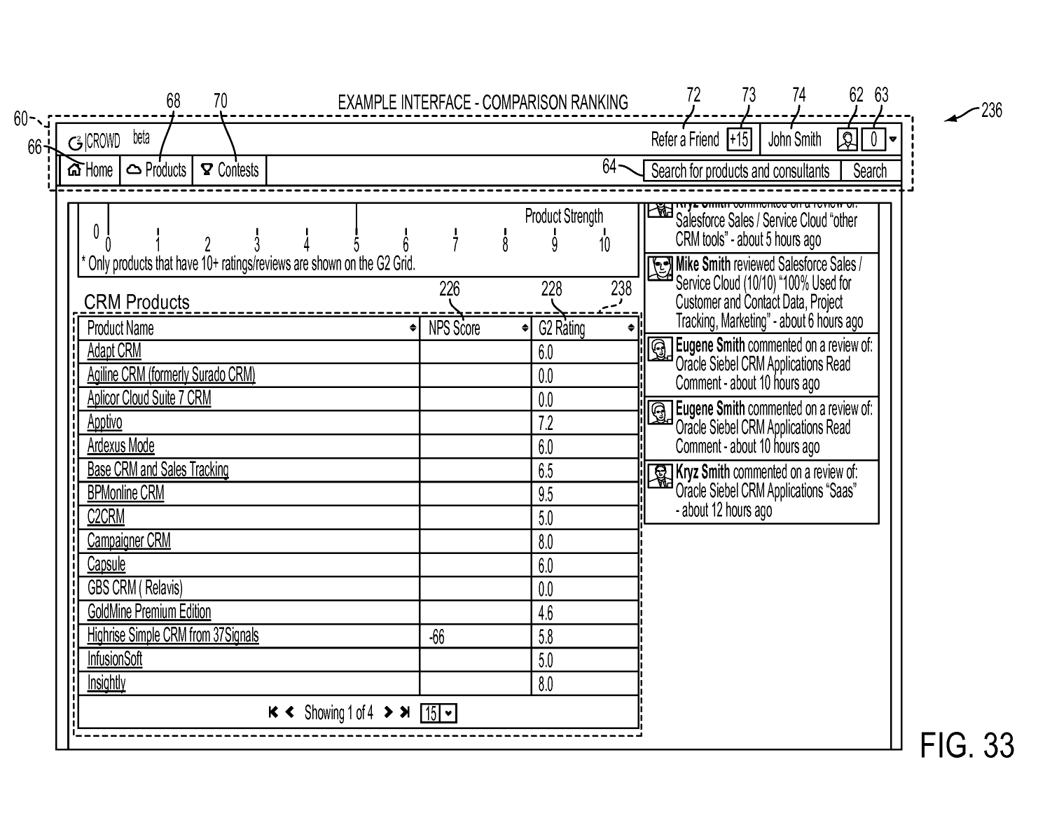

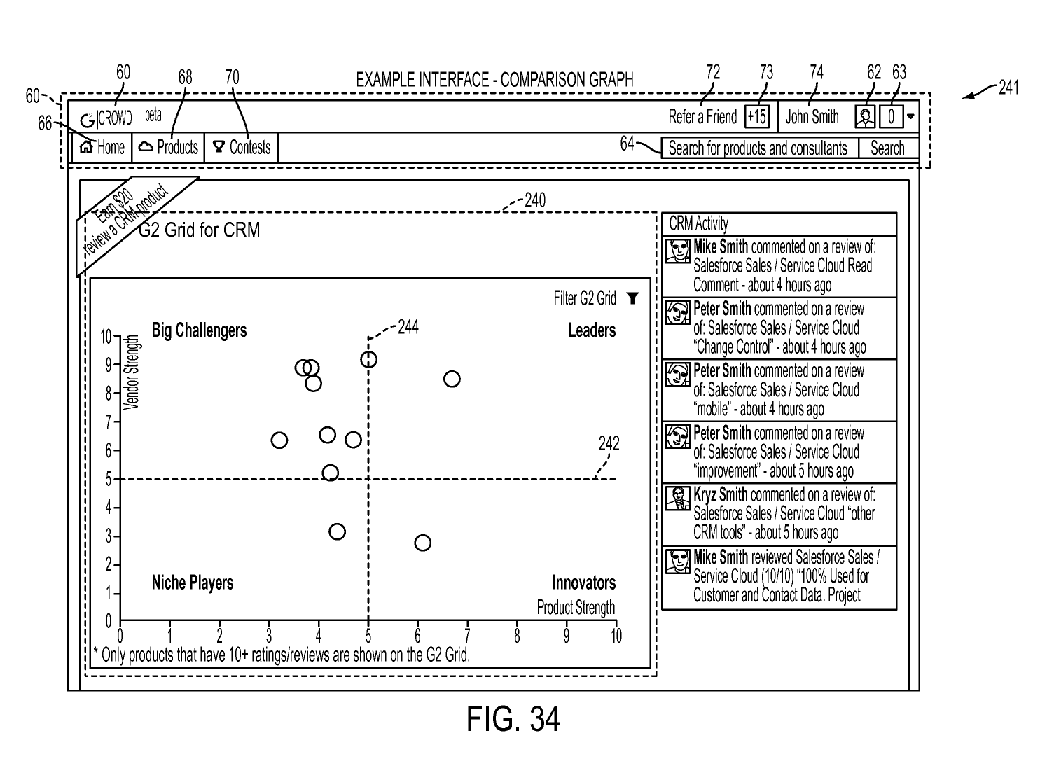

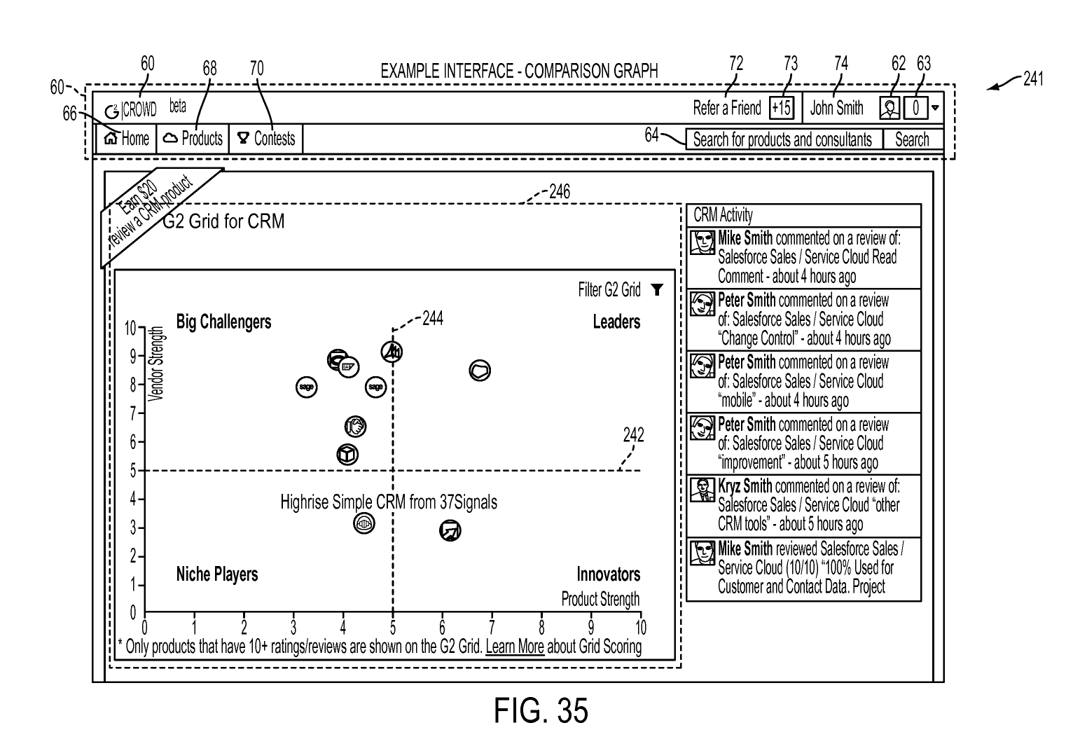

In the example interfaces shown in FIGS. 9-10, the top five contributing users in the CRM category have point balances ranging from 309 points to 545 points. As shown, the contest period in this example starts on 01/01 (January 1^{st}) and ends on 01/31 (January 31^{st}). In this example, the users, David, Kryz, Oliver, Peter and Paul are each in the running for the iPad® Mini because they have each earned over 300 points within the CRM category. Also, each of these users is one of the top five contributors in the CRM category. The users, Eugene and Nate, are each in the running for the $100 Amazon® Gift Certificate because they each earned 500 points across all marketed offering categories, and they each are one of the top three users with the most points across all marketed offering categories. The users, Alex, Jamie and Andrew, are each in the running for the $50 Amazon® Gift Certificate because they are each one of the next ten users with the most points across all categories, excluding the top three users.

The contribution system 12 includes a plurality of contribution collection interfaces. These interfaces enable the users to contribute information related to marketed offerings. In the example shown in FIG. 11, the interface 102 displays a plurality of selectable marketed offering summaries 104. In this example, the user hovers his/her mouse pointer over the action symbol 106 of the summary 108. In response, the contribution system 12 displays the action options 110 illustrated in FIG. 12. The action options include “Read Reviews,” “Use This,” “Follow This,” “Rate This” and “Review This.” When the user selects “Read Reviews,” the contribution system 12 displays the reviews or contributions associated with the marketed offering identified by summary 106. When the user selects “I Used This,” the contribution system 12 displays an interface enabling the user to input the marketed offerings which the user has used in the past. This information, list of used marketed offerings, is available to other users. When the user selects “Follow This,” the contribution system 12 displays information which facilitates the user's tracking and following of the marketed offering. This information may include, for example, periodic or event-based reports regarding the changing scores of the marketed offering.

Referring to FIG. 13, when the user selects “Rate This,” the contribution system 12 enables the user to submit an abbreviated contribution, as described above in Table A. For the abbreviated contribution, the contribution system 12 displays the grading template 112. In one example, the grading template 112 displays the question, “How likely is it that you would recommend SalesForce/Service Cloud to a friend or colleague?” accompanied by a scale of 0-10. The user may select a grade value or grade of 0, 1, 2, 3, 4, 5, 6, 7, 8, 9 or 10. After providing that contribution, the user completes the abbreviated contribution process by clicking the Done symbol 114.

If the user so desires, the user may provide a full contribution by selecting “Review This.” In response, the contribution system 12 provides a series of interfaces, such as the example interfaces illustrated in FIGS. 14-17. The full contribution collection interface 118 includes: (a) the grading template 112; (b) a free-form template 122 which includes a series of designated open-ended questions or prompts with associated blank typing fields for free-form textual input or text entry by the user, such as “Title for your review,” What do you like best?”, “What do you dislike?”, “Recommendations to others considering Sage CRM;” and (c) a pull-down menu template 124 which includes a plurality of designated open-ended questions or prompts with associated pull-down answers, such as the following: (i) “What is your primary role when using this product?” with selectable pull-down answers including User, Administrator, Executive Sponsor, Internal Consultant, Consultant, and Analyst/Tech Writer; (ii) “What is your level of experience with this product?” with selectable pull-down answers including Trial/Evaluation Only, Still Implementing, Failed to go Live, Less than 1 Year, 1-3 Years, 3-5 Years, >5 Years, and Multiple Implementations; and (iii) “Is Microsoft Dynamics CRM headed in the right direction?” with selectable pull-down answers including Yes, No, and Don't Know.

Also, the full contribution collection interface 118 includes an additional questions template 126. The templates 126 includes the following: (a) the prompt, “Meets Requirements” with a grade scale of 1-7, where 1 represents “Missing Features” and 7 represents “Everything I Need;” (b) the prompt, “Ease of Use” with a grade scale of 1-7, where 1 represents “Painful” and 7 represents “Delightful;” (c) the prompt, “Ease of Setup” with a grade scale of 1-7, where 1 represents “Heavy” and 7 represents “Light;” (d) the prompt, “Ease of Admin” with a grade scale of 1-7, where 1 represents “Difficult” and 7 represents “Easy;” (e) the prompt, “Quality of Support” with a grade scale of 1-7, where 1 represents “Terrible” and 7 represents “Amazing;” and (f) the prompt, “Ease of Doing Business With” with a grade scale of 1-7, where 1 represents “Unreasonable” and 7 represents “Pleasurable.”

As illustrated in FIG. 16, the full contribution collection interface 118 includes an implementation pull-down menu template 130 which has a plurality of designated open-ended questions or prompts with associated pull-down answers, such as the following examples: (a) “Did you deploy in the cloud or on-premise?” with selectable pull-down answers; (b) “Which edition of this CRM Product are you using?” with selectable pull-down answers; (c) “How long did it take you to go live?” with selectable pull-down answers; (d) “In what year did you first roll out your current CRM solution?” with selectable pull-down answers; (e) “Number of Users Purchased” with selectable pull-down answers; (f) “What percentage of your users have fully adopted this system?” with selectable pull-down answers; (g) “How did you implement?” with selectable pull-down answers; and (h) “Which service provider did you use to implement?” with selectable pull-down answers.

As illustrated in FIG. 17, the full contribution collection interface 118 includes a deal template 132 which has a plurality of designated open-ended questions or prompts with associated pull-down answers, such as the following: (a) “Price” with a grade scale of 1-7, where 1 represents “Inexpensive” and 7 represents “Expensive;” (b) “Your one-time costs for setting up this product” with selectable pull-down answers; (c) “What is your annual recurring cost for using this product/service?” with selectable pull-down answers; (d) “What is the term of your contract?” with selectable pull-down answers; (e) “What percentage off list price did you receive?” with selectable pull-down answers; and (f) “What is your company's estimated ROI on this product (payback period in months)?” with selectable pull-down answers.

By selecting or not selecting the box in the anonymity field 134, the user may determine whether or not to provide his/her contribution anonymously. In one embodiment, the contribution system 12 requires the user to provide a certification before submitting his/her contribution. In the example shown, it is mandatory for the user to select the box in the certification field 136, certifying that the contribution is based on his/her own experience, the contribution is his/her genuine opinion, and he/she is not employed by the vendor of the applicable marketed offering. The validation template 138 enables the user to upload a screenshot as evidence for validating his/her contribution. After that step, the user may complete the full contribution process by clicking the “Submit Review” symbol 140.

To earn additional points, the user may click the “Review Features” symbol 142. In response, the contribution system 12 displays the features contribution collection interface 144 as illustrated in FIGS. 18-20. The interface 144 includes a plurality of feature grading templates related to different main features. The questions and content of the feature grading templates vary with the type of marketed offering category. In the example shown in FIGS. 18-20, the selected marketing offering, Sage CRM, is within the CRM category. Accordingly, the interface 144 includes a plurality of grading templates related to the CRM category, including a Sales Force Automation grading template 146, a Marketing Automation grading template 148, a Customer Support grading template 150 and an Integration grading template 152. If the marketed offering category were healthcare insurance, the feature grading templates would include questions and prompts related to the healthcare insurance industry.

The Sales Force Automation grading template 146 includes a plurality of topics. In the example shown, the topics include Contact & Account Management, Opportunity & Pipeline Management, Task/Activity Management, Territory & Quota Management, Desktop Integration, Product & Price List Management, Quote & Order Management, and Customer Contract Management. Adjacent to each topic is a grade scale, enabling the user to select a grade value or grade from 1-7. The number 1 represents Terrible, and the number 7 represents Amazing.

The Marketing Automation grading template 148 includes a plurality of topics as illustrated in FIG. 19. In the example shown, the topics include Email Marketing, Campaign Management, Lead Management, and Marketing ROI Analytics. Adjacent to each topic is a grade scale, enabling the user to select a grade value or grade from 1-7. The number 1 represents Terrible, and the number 7 represents Amazing.

The Customer Support grading template 150 includes a plurality of topics as illustrated in FIG. 19. In the example shown, the topics include Case Management, Customer Support Portal, Knowledge Base, Call Center Features, and Support Analytics. Adjacent to each topic is a grade scale, enabling the user to select a grade value or grade from 1-7. The number 1 represents Terrible, and the number 7 represents Amazing.

The integration grading template 152 includes a plurality of topics as illustrated in FIG. 20. In the example shown, the topics include Data Import & Export Tools, Integration APIs, and Breadth of Partner Applications. Adjacent to each topic is a grade scale, enabling the user to select a grade value or grade from 1-7. The number 1 represents Terrible, and the number 7 represents Amazing.

Referring to FIG. 20, the features contribution collection interface 144 also includes the integration field 154. Integration field 154 is associated with the question, “To which other systems have you integrated this product?” The field 154 provides an empty space for the user to enter text or textual input, in free-form fashion, answering the question. The features contribution collection interface 144 also includes the anonymity field 134, certification field 136 and validation template 138. To submit the features contribution, the user selects the Submit Review symbol 156.

After a user has submitted a contribution, the contribution system 12 stores the contribution in association with the related marketed offering and also in association with the user's profile. In the example shown in FIGS. 21-22, the interface 158 of the contribution system 12 displays the contribution provided by the user, Paul, regarding VistaPrint. The interface 158 includes a commentary section 160 as illustrated in FIG. 22. The commentary section 160 displays the question, “Was this review helpful?” adjacent to a Yes symbol and a No symbol. If the reader were to select Yes, the contribution system 12 would allocate a positive mark to the user Paul. If the reader were to select No, the contribution system 12 would allocate a negative mark to the user Paul. According to Table A above, the contribution system 12 would then adjust the user Paul's point balance based on the allocated mark.

The commentary section 160 also includes a Comments link 162 and an Add a Comment link 164. If the reader clicks the Comments link 162, the contribution system 12 displays the comments of other users associated with this contribution. If the user clicks the Add a Comment link 164, the contribution system 12 displays a template to the reader, providing the reader with blank lines for entering textual input or text entry in free-form. If the user has validated his/her contribution, the interface 164 displays a validation message or indicator, such as the “VALIDATED REVIEW” message 166 shown in FIG. 23.

Referring now to FIGS. 24-27, the contribution system 12 stores user-specific or user data for each user's profile. In this example, a user, John, is reviewing the profile of a user, Paul. As illustrated in FIG. 24, the example interface 168 displays: (a) the user's name, employment title, employer, employer description and employment description; and (b) the marketed offerings graded by the user, including a summary of the grades and points earned for each such marketed offering. As illustrated in FIG. 25, the example interface 170 displays the marketed offerings which are followed, tracked or monitored by the user. When the user, John, clicks the used products link 171, the contribution system 12 displays a list of the marketed offerings used in the past by the user, Paul. As illustrated in FIG. 26, the example interface 172 displays the user profile details, including the user's name, title, industry, website, Twitter identification, employer's name and employer's size in terms of employees, together with other fields which, in this example, have not been populated, including fields for Skype identification, phone number and biography.

As illustrated in FIG. 27, the example interface 174 displays a contribution summary 176 of the user's contributions. As illustrated in the example shown, the contribution summary 176 lists the user's point-earning activities, including contributions submitted, positive and negative marks by other users, comments submitted, referrals and referral contributions. For each such activity, the list includes the points added or deducted from the user's account to arrive at the point accumulation or point balance 178.

In one embodiment, the contribution system 12 includes a live, real time or instant contribution interface. The instant contribution interface displays one or more instant inquiry links. In one embodiment, each of the instant inquiry links is associated with a different marketed offering or marketed offering category. In another embodiment, the system includes one or more general, instant inquiry links which are not coupled to a particular marketed offering. When a user clicks one of the instant inquiry links, the interface displays a field or template, enabling the user to post a question, for example, “Which CRM software is best for deployment on smartphones?” The system sends an alert to the other users regarding the question. The alerted users have the opportunity to instantly reply to the question. The contribution system 12, in this embodiment, includes point-earning conditions related to this instant help process. For example, a user may earn points for posting a question, and users may earn points for posting replies. In one embodiment, the first user to reply earns more points than users who subsequently reply.

Scoring System

As described above, the main system 10, illustrated in FIG. 1, includes the scoring system 14 which, in one embodiment, is operatively coupled to the contribution system 12. Depending upon the embodiment, the scoring system 14 can include the scoring system 180 illustrated in FIG. 28 or the scoring system 182 illustrated in FIG. 29.

The scoring system 12, in one embodiment, relies upon factors 185 as illustrated in FIG. 30. Factors 185 include contributor-derived factors 187 and supplemental factors 189. The contributor-derived factors 187 are derived from the contribution system 12. Referring back to Table A, a user can submit a Full Attributed Contribution, a Full Anonymous Contribution or an Abbreviated Contribution. In each such contribution, the user submits at least one grade value selected from a scale of recommendation grade values. These grade values are the basis for the contributor-derived factors used by the scoring system 14. Depending upon the embodiment, other data submitted by users of the contribution system 12 can be the basis for the contributor-derived factors.

The supplemental factors 189, on the other hand, are derived from data sources other than the contribution system 12. These data sources, in one embodiment, provide different categories of data, including: (a) social network data or social data; (b) network activity data, such as website and webpage statistics; and (c) business, corporate or company data. As described further below, in one embodiment these data sources include the Google growth trend data source, the Google page rank data source, the Twitter follower data source, the Klout data source, the Alexa site growth data source, the LinkedIn data source, the Insideview data source, the Glassdoor data source and one or more company financials data sources.

The scoring system 14 can have different levels of automation depending upon the embodiment. Scoring system 180, illustrated in FIG. 28, has one level of automation. Scoring system 182, illustrated in FIG. 29, has a greater level or a full level of automation.

In one embodiment illustrated in FIG. 28, the scoring system 180 includes score determination logic 183 and data storage device 194. In this embodiment, the score determination logic 183 is manually implemented through the use of spreadsheets and tables. The score determination logic 183 includes: (a) one or more recommendation scoring algorithms 184; (b) one or more marketed offering scoring algorithms 186; (c) one or more company scoring algorithms 188; and (d) a plurality of scale conversion tables 190.

In operation of this embodiment, initially the implementor (i.e., a person) inputs the factors 191 into the score determination logic 183, including, but not limited to, the contributor-derived factors 187 and the supplemental factors 189. After applying the score determination logic 183 to the factors 191, the implementor determines the score data 192. The implementor then loads the scoring data 192 into the data storage device 194.

The data storage device 194 includes computer code or computer-readable instructions 196, the scoring data 192 and one or more comparison graph templates 198. The scoring system 180 is accessible by a server or processor 200 which, in turn, is accessible by a network access device 202, such as a personal computer or smartphone. The network access device 202 has one or more output devices 204, such as a monitor, and one or more input devices 206, such as a touchscreen or button.

In operation, the processor 200 reads the instructions 196, which causes the processor 200 to process the scoring data 192 and populate the comparison graph templates 198 with data. In one embodiment, each comparison graph template 198 includes a structure based on an X-axis, Y-axis and two or more divider lines. The divider lines define a grid, such as a quadrant defining four sections or quadrilaterals, or another suitable grid defining more than four sections, such as quadrilaterals or polygons. In operation, a user may provide an input through an input device 206 related to one or more marketed offerings. In response, the output device 204 displays scores, ranking lists and graphs related to such marketed offerings.

In one embodiment illustrated in FIG. 29, the scoring system 182 includes a data storage device 214. The data storage device 214 includes score determination logic 216 and computer code or computer-readable instructions 218. The score determination logic 216 includes: (a) one or more recommendation scoring algorithms 184; (b) one or more marketed offering scoring algorithms 186; (c) one or more company scoring algorithms 188; (d) one or more scale conversion algorithms 220; and (e) one or more comparison graph templates 198. The scoring system 182 is accessible by a processor 200 which, in turn, is accessible by a network access device 202, such as a personal computer or smartphone. The network access device 202 has one or more output devices 204, such as a monitor, and one or more input devices 206, such as a touchscreen or button.

The factors 191 are fed into the data storage device 214. In one embodiment, the contributor system 12 feeds the contributor-derived factors 187 directly into the data storage device 214, and an implementor (i.e., a person) enters part or all of the supplemental factors 189 into the data storage device 214. In another embodiment, external servers or processors feed the supplemental factors 189 directly into the data storage device 214.

In operation, the processor 200 reads the instructions 212, which causes the processor 200 to: (a) apply the algorithms 184, 186, 188 and 220, which generates the scoring data 192; and (b) process the scoring data 192; and (c) populate the comparison graph templates 198 with data. A user may provide an input through an input device 204 related to one or more marketed offerings. In response, the output device 204 displays scores, ranking lists and graphs related to such marketed offerings.

The score determination logic 183 and 216 include mathematical formulas, routines and logic. The processor, applying this logic, is operable to receive data derived from contributing users and then output one or more scores. In one embodiment, the recommendation scoring algorithms 184 include a Net Promoter Score (NPS) algorithm or NPS algorithm 222. In one example of one embodiment, the NPS algorithm 222 produces an NPS score 226 based on the formula provided in the following Table C:

TABLE C
NPS = P − D

| | | |
|---|---|---|
| where | P: | the percentage of users who are Promoters |
| | D: | the percentage of users who are Detractors |
| | Promoter: | a contributing user who, on a scale of 0-10, |
| | | inputs a grade in the range of 9-10 in response to |
| | | the following question: How likely is it that you |
| | | would recommend XYZ marketed offering to a |
| | | friend or colleague? |
| | Detractor: | a contributing user who, on a scale of 0-10, |
| | | inputs a grade in the range of 0-6 in response to |
| | | the following question: How likely is it that you |
| | | would recommend XYZ marketed offering to a |
| | | friend or colleague? |

User grades, in response to such question, in the range of 7-8 are considered “passive” and are not incorporated into the NPS algorithm 222. The NPS score 226 can be positive or negative, ranging from −100 to 100. In one example, P is 70% and D is 10% so the NPS score is 60. In another example, P is 30% and D is 60% so the NPS score is −30.

In one example of one embodiment, the marketed offering scoring (MOS) algorithm or MOS algorithm 186 produces or determines an MOS score 228 based on the formula provided in the following Table D:

TABLE D
MOS = (Major Weight A × Satisfaction Score POS) +
(Major Weight B × Second Level Satisfaction Score PSL) +
(Major Weight C × Web-Social Score PWSI)

| | | |
|---|---|---|
| where | A + B + C = | 100% |
| | A = | a + b + c |
| | B = | d + e + f + g + h + i |
| | C = | j + k + l |
| | a, b, c, d, e, | Each is a minor weight factor in percentage form |
| | f, g, h, l, j, | (0-100%), and, when added all together, the |
| | k, l: | minor weight factors must have a sum of 100%. |
| | POS = | [(a × (lr + b)) × ((nps + 100)/20) + (c × (hr × |
| | | 10))]/A |
| | lr: | average likelihood to recommend (1-N scale) |
| | | derived from contributions of users of the |
| | | contribution system |
| | Hr | percentage of users believing that the marketed |
| | | offering is headed in the right direction (0-100% |
| | | scale) derived from contributions of users of the |
| | | contribution system |
| | PSL = | [((d × fu) + (e × su) + (f × eu) + (g × es) + |
| | | (h × ea) + (i × eb)) × 10/7]/B |
| | fu: | functionality average score (0-M scale) derived |
| | | from contributions of users of the contribution |
| | | system |
| | su: | support average score (0-M scale) derived from |
| | | contributions of users of the contribution system |
| | eu: | ease of use average score (0-M scale) derived |
| | | from contributions of users of the contribution |
| | | system |
| | es: | ease of support average score (0-M scale) |
| | | derived from contributions of users of the |
| | | contribution system |
| | ea: | ease of administration average score (0-M scale) |
| | | derived from contributions of users of the |
| | | contribution system |
| | eb: | ease of doing business average score (0-M |
| | | scale) derived from contributions of users of the |
| | | contribution system |
| | PWSI = | [(j × pgp) + (k × pgr) + (l × psi)]/C |
| | pgp: | Google page rank for marketed offering webpage |
| | | (0-N scale) derived from Google data source |
| | pgr: | Scaled growth score: scale conversion table |
| | | applied to Google growth trend derived from |
| | | Google data source, converting each of the |
| | | eleven percentage ranges to a score in the range |
| | | of 0-N score (0-N scale) |
| | psi: | social impact average for marketed offering: |
| | | [(Scaled Twitter score (0-N scale) based on a |
| | | scale conversion table applied to different ranges |
| | | of quantities of twitter followers derived from |
| | | Twitter data source, converting each range to a |
| | | score between 0-N) + (Scaled Klout score (0-N |
| | | scale) based on a scale conversion table applied |
| | | to eleven ranges of the Klout score (0-100) |
| | | derived from Klout data source, converting each |
| | | range to a score in the range of 0-N)]/2 |
| | N: | suitable number for an upper limit of a range |
| | M: | suitable number, different from N, for an upper |
| | | limit of a range |

The Klout score is derived from a data source controlled by Klout, Inc. Klout, Inc. generates Klout scores for companies, organizations and individuals based on the traffic to the Facebook, Twitter, and Google Plus accounts of such entities. Klout, Inc. applies designated algorithms and outputs an aggregated ranking or Klout score, ranging from 0-100.

As provided in Table D, the MOS algorithm 186 has a plurality of contributor-derived factors 187, including “Ir,” “Hr,” “fu,” “su,” “eu,” “es,” “ea” and “eb.” Also, MOS algorithm 186 has a plurality of supplemental factors 189, including “pgp,” “pgr,” and “psi.” The “pgp” and “pgr” factors may be referred to herein as network activity factors. A network activity factor is a type of supplemental factor. In one embodiment, the network activity factors include, or are derived from, website statistics or web presence statistics. The “psi” factor may be referred to herein as a social factor. In one embodiment, the social factor includes, or is derived from, online social attention data collected through social networking websites and applications.

In one embodiment, the scoring system 180 includes a plurality of scale conversion tables 190 as illustrated in FIG. 28. Each scale conversion table 190 converts non-scaled data to a scale of values. For example, the non-scaled data may be derived from a data source, and the data source may output a data point between a minimum level and a designated high level (“H”). In the case of Twitter followers, the minimum level is 0 followers, and H may be designated as 100,000 or more followers. The following Table E provides the logic for converting non-scaled data to scaled data:

TABLE E

| Offering Data Range | Score (0-10) |
|---|---|
| (0/11) × H to (1/11) × H | 0 |
| [((1/11) × H) + 1] to (2/11) × H | 1 |
| [((2/11) × H) + 1] to (3/11) × H | 2 |
| [((3/11) × H) + 1] to (4/11) × H | 3 |
| [((4/11) × H) + 1] to (5/11) × H | 4 |
| [((5/11) × H) + 1] to (6/11) × H | 5 |
| [((6/11) × H) + 1] to (7/11) × H | 6 |
| [((7/11) × H) + 1] to (8/11) × H | 7 |
| [((8/11) × H) + 1] to (9/11) × H | 8 |
| [((9/11) × H) + 1] to (10/11) × H | 9 |
| [((10/11) × H) + 1] to (11/11) × H | 10 |
| >((11/11) × H) | 10 |

In the scoring system 182 illustrated in FIG. 29, the scale conversion algorithms 188 incorporate the logic of the scale conversion tables 190. In one embodiment, the scale conversion algorithms 188 include linear interpolation formulas or programs. In automated fashion, the processor 200 applies the scale conversion algorithms 188 to convert non-scaled data to scaled data.

In one example of one embodiment, the company scoring (CS) algorithm or CS algorithm 188 produces or determines a CS score 230 based on the formula provided in the following Table F:

TABLE F
CS = (Major Weight A × Satisfaction Score for Company COS) +
(Major Weight B × Company Scale Score CSS) +
(Major Weight C × Web-Social Score for Company CWSI)

| | |
|---|---|
| A + B + C = | 100% |
| A = | a + b |
| B = | d + e + f |
| C = | j + k + l |
| a, b, d, e, f, | Each is a minor weight factor in percentage form |
| j, k, l: | (0-100%), and, when added all together, the |
| | minor weight factors must have a sum of 100%. |
| COS = | [(a × es) + (b × qs)]/A |
| es: | average employee satisfaction rating derived |
| | from Glassdoor data source (1-N scale) |
| qs: | company Q score derived from LinkedIn data |
| | source or Insideview data source (0-100 scale) |
| CSS = | If the company's revenue is known, |
| | CSS = [(d × ee) + (e × as) + f × rs)]/B |
| | If the company's revenue is unknown, |
| | CSS = [((d + f) × ee) + (e × as)]/B |
| ee: | employee score (0-N scale) derived from users of |
| | the contribution system |
| as: | company age score (0-N score) derived from a |
| | company financial data source, such as Dun & |
| | Bradstreet or the U.S. Securities & Exchange |
| | Commission, based on a scale conversion table |
| | applied to different ranges of company ages, |
| | converting each range to a score between 0-10 |
| rvs: | revenue size score (0-N scale) derived from a |
| | company financial data source, such as Dun & |
| | Bradstreet or the U.S. Securities & Exchange |
| | Commission, based on a scale conversion table |
| | applied to different ranges of company ages, |
| | converting each range to a score between 0-N |
| rgs: | revenue growth score (0-N scale) derived from a |
| | company financial data source, such as Dun & |
| | Bradstreet or the U.S. Securities & Exchange |
| | Commission, based on a scale conversion table |
| | applied to different ranges of company ages, |
| | converting each range to a score between 0-N |
| rv = | (rvs × 0.80) + (rgs × 0.20) |
| CWSI = | [(j × cpg) + (k × cgr) + (l × csi)]/C |
| cpg: | Google page rank for company webpage (0-N |
| | scale) derived from Google data source |
| cgr = | (cggt + ats)/2 |
| cggt: | 12-month Google growth trend for company |
| | name derived from Google data source and |
| | based on a scale conversion table applied to |
| | different ranges of trend data, converting each |
| | range to a score between 0-N |
| ats = | (0.8 × ars) + (0.2 × ags) |
| ars: | Alexa site rank score for corporate site derived |
| | from Alexa data source and based on a scale |
| | conversion table applied to different ranges of |
| | rankings, converting each range to a score |
| | between 0-N (0-N scale) |
| ags: | alexa site growth for corporate site derived from |
| | Alexa data source and based on a scale |
| | conversion table applied to different ranges of |
| | growth data, converting each range to a score |
| | between 0-N (0-N scale) |
| csi: | social impact average for company: [(Scaled |
| | Twitter score (0-N scale) based on a scale |
| | conversion table applied to different ranges of |
| | quantities of Twitter followers derived from |
| | Twitter data source, converting each range to a |
| | score between 0-N) + (Scaled Klout score (0-N |
| | scale) based on a scale conversion table applied |
| | to eleven ranges of the Klout score (0-100) |
| | derived from Klout data source, converting each |
| | range to a score in the range of 0-N)]/2 |
| N: | suitable number for an upper limit of a range |

The CS algorithm 188 has a plurality of supplemental factors 189. As provided in Table F, the supplemental factors of CS algorithm 188 include “es,” “qs,” “ee,” “as,” “rvs,” “rgs,” “rv,” “cpg,” “cgr,” “cggt,” “ats,” “ars,” “cgs” and “csi.” These supplemental factors include several types or categories of factors, including company factors, network activity factors and social factors. The company factors include the following factors: “es,” “qs,” “ee,” “as,” “rvs” and “rgs.” The network activity factors include the following factors: “cpg,” “cggt,” “ars” and “ags.” The social factors include the “csi” factor.

In one embodiment, as illustrated above, the algorithms for the NPS score 226 and MOS score 228 are interrelated. For example, the NPS algorithm 222 is based, in part, on a user's reply to the following question, “How likely is it that you would recommend XYZ marketed offering to a friend or colleague?” as provided in Table C above. This reply is the basis for the likelihood recommendation (Ir) factor included in the MOS algorithm 186 as set forth in Table D above. In one embodiment, the likelihood recommendation (Ir) factor is the same as the likelihood recommendation score 227 illustrated in FIG. 4. A change in the “Ir” factor or likelihood recommendation score 227 results in a change in the MOS score 228.

Based on the score determination logic 183 or 216 described above, the scoring system 14 generates and updates the following scores for each marketed offering: (a) an NPS score 226; (b) the likelihood recommendation score 227; and (c) an MOS score 228. The score determination logic 183 or 216 generates and updates the CS score 230 for each company or organization associated with a marketed offering. The system displays or indicates the scores 226, 227, 228 and 230 to the users. For example, each marketed offering summary displays the likelihood recommendation score 227 and NPS score 226, as illustrated in FIG. 4.

As illustrated in FIG. 31, the score determination logic of the scoring system 14 receives data and data feeds from a plurality of different data sources, including the contribution system 12 as a data source, Google growth trend data source, Google page rank data source, Twitter follower data source, Klout data source, Alexa site growth data source, LinkedIn data source, Insideview data source, Glassdoor data source and company financials data sources.

The data received from the contribution system 12 is derived, at least in part, from the grades, comments and information provided by users or other contributors. Accordingly, the data received from the contribution system 12 is contributor-derived data, which is the basis for contributor-derived factors. On the other hand, the data received from the other data sources is supplemental-derived data, which is the basis for supplemental factors.

Depending upon the embodiment, the data sources can include electronic databases, electronic data feeds or non-electronic or static reports. In one embodiment, the processor 200 pulls data from one or more of the data sources and inputs the pulled data into the score determination logic 183 or 216. In another embodiment, a person extracts data from one or more of these data sources and inputs the extracted data into the score determination logic 183 or 216.

In yet another embodiment, the processor 200 pulls data from some of the data sources, and an implementor or person extracts data from the other data sources. For example, in one embodiment, the processor 200 pulls grade data from the contribution system 12 data source, and the processor 200 updates the scores 224 based on the pulled grade data. In such embodiment, a person extracts the non-grade data from the other data sources and then inputs the non-grade data for the processor's further updating of the scores 224.

In an alternative embodiment, the processor 200 is programmed to extract or parse data from an interface of one or more of the data sources illustrated in FIG. 31. In one embodiment, the scoring system 14 includes one or more Application Programming Interfaces (APIs). The APIs facilitate data communication between the scoring system 14 and the interfaces of the data sources, enabling the processor 200 to automatically extract data from the data sources.

In one embodiment, when the processor 200 pulls data, the processor 200 performs this step in real time, thereby updating the scores 224 in real time. For example, marketed offering XYZ may have the following scores at 9:35 am on Jun. 4, 2013: NPS of 42 and likelihood recommendation score of 8.7/10. At 9:36 am on Jun. 4, 2013, a user with a negative experience submits a contribution for marketed offering XYZ. The processor 200 detects, reads or receives a signal when the user's submission is complete. The processor 200 then applies the score determination logic 183 or 216, and then the processor updates the scores 224. As a result, marketed offering XYZ has the following scores at 9:36 am on Jun. 4, 2013: NPS of 39 and a likelihood recommendation score of 7.3/10.

In one embodiment, as described in this example, the processor 200 immediately detects, reads or receives a signal as soon as the user's submission is complete. In another embodiment, the processor 200 periodically polls or periodically checks for new data from the contribution system 12 data source. For example, the periodic checks may occur every 60 seconds, every second, every millisecond or based on any other suitable time frequency. When the processor 200 detects new data, the processor 200 then updates the scores 224 based on the new data.

As illustrated in FIG. 32, the scoring system 14 enables users to compare multiple marketed offerings as shown in the example interface 232. If the user clicks the Compare All Products in CRM link 234, the scoring system 14 displays a list or report which indicates the differences between the marketed offerings. Depending upon the embodiment, the compared items can include grades provided by contributing users, features, and other data points collected from contributing users.

In one example of one embodiment illustrated in FIG. 33, the scoring system 14 displays an interface 236 in response to the user's clicking of the Compare All Products in CRM link 234. The interface 236 includes a ranking report or ranking list 238. The ranking list 238 is sortable according to the NPS score 226 or likelihood recommendation score 227.

In one embodiment, the processor 200 applies the template data of the one or more comparison graph templates 198 (indicated in FIGS. 28-29) to generate comparison graph 240. As described above, the comparison graph template 198 includes a structure including an X-axis, a Y-axis and two or more divider lines. The divider lines define a grid, such as a quadrant defining four section or quadrilaterals, or another suitable grid defining more than four sections, quadrilaterals or polygons. In operation, the scoring system 14 populates the comparison graph template 198 with scoring data and plotted symbols. The result is the comparison graph 240 within the example interface illustrated in FIG. 34.

In the example comparison graph 240 shown in FIG. 34, the comparison graph template includes an X-axis corresponding to the marketed offering strength. The X-axis plots the MOS scores 228. The comparison graph template also includes a Y-axis corresponding to company strength. The Y-axis plots the CS scores 230. Also, the comparison graph template 240 includes a horizontal divider line 242 and a vertical divider line 244. The divider lines 242 and 244 form quadrants. As illustrated, the quadrants correspond to four performance categories, including Big Challengers, Leaders, Niche Players and Innovators. The Big Challengers quadrant relates to relatively strong companies with developing marketed offerings. The Leaders quadrant relates to the strongest companies with the strongest marketed offerings. The Niche Players quadrant relates to relatively small, new or weak companies with relatively weak marketed offerings. The Innovators quadrant relates to relatively small, new or weak companies with relatively strong marketed offerings.

In another embodiment illustrated in FIG. 35, the processor 200 populates the comparison graph template 198 to generate comparison graph 246. Comparison graph 246 is the same as comparison graph 240 except that graph 246 displays the different symbols, logos or icons of the different companies or marketed offerings.

As provided in Tables D and F above, the MOS algorithm 186 and CS algorithm 188 each has major weight factors or major weights A, B and C. Each such major weight is based on the sum of a set of minor weight factors selected from the group, “a”-“l.” The different minor weights are multipliers of different parts of the sub-algorithms of the algorithms 186 and 188. For example, minor weight “a” is a multiplier of an “average likelihood to recommend” parameter while minor weight “g” is a multiplier of an “ease of use” parameter. A major weight, which is the sum of a set of minor weights, is a multiplier of a particular part of the algorithm 186 or 188. For example, major weight A is a multiplier of the satisfaction score POS while major weigh C is a multiplier of the web-social score.

In one embodiment, the scoring system 14 has an emphasis setting interface. The emphasis setting interface displays a plurality of selectable or customizable settings for the magnitudes of the minor weights. The user can customize the weightings based on what is most important to the user. For example, if the user decides that ease of use is significantly more important than social impact, the user may increase the magnitude of the ease of use minor weight relative to the social impact minor weight. The scores 224 will therefore reflect this weight emphasis set by the user.

In one embodiment, the main system 10 includes a plurality of purchase links associated with the marketed offerings. When a user clicks on a purchase link, the system displays information to facilitate the user's purchase of the associated marketed offering. This information may include, for example, a link to a vendor's website where the user can order or purchase the marketed offering.

Methods

In one embodiment, the main system 10 is implemented as a method. The main system method includes all of the functionality, steps and logic of the main system 10.

In one embodiment, the contribution system 12 is implemented as a method. The contribution system method is a method for incentivizing contribution of information. This method includes operating at least one processor in accordance with a plurality of computer-readable instructions, wherein the processor performs a plurality of steps. These steps include the following:
(a) receive information from a user, wherein the received information is related to one of a plurality of different marketed offerings;
(b) determine whether the received information satisfies a point-earning condition;
(c) establish a point balance for the user, wherein the point balance depends upon the determination;
(d) determine whether the point balance satisfies an award condition; and
(e) allocate an award to the user in response to the point balance satisfying the award condition.

In one embodiment, the scoring system 14 is implemented as a method. The scoring system method is a method for generating a score. This method includes operating at least one processor in accordance with a plurality of computer-readable instructions, wherein the processor performs a plurality of steps. These steps include the following:
(a) receive data associated with a plurality of different marketed offerings;
(b) receive a contributor-derived factor associated with one of the marketed offerings, wherein the contributor-derived factor is derived from a contribution data source, and wherein the contribution data source has information derived from one or more contributors;
(c) receive a supplemental factor associated with one of the marketed offerings, wherein the supplemental factor is derived from a supplemental data source;
(d) apply at least one mathematical formula to the received contributor-derived factor and the received supplemental factor;
(e) determine a score based on the application; and
(f) display the score in association with the marketed offering.

Network

Referring back to FIG. 1, the network 18 can be any suitable type of network. Depending upon the embodiment, the network 18 can include one or more of the following: a wired network, a wireless network, a local area network (LAN), an extranet, an intranet, a wide area network (WAN) (including, but not limited to, the Internet), a virtual private network (VPN), an interconnected data path across which multiple devices may communicate, a peer-to-peer network, a telephone network, portions of a telecommunications network for sending data through a variety of different communication protocols, a Bluetooth communication network, a radio frequency (RF) data communication network, an infrared (IR) data communication network, a satellite communication network or a cellular communication network for sending and receiving data through short messaging service (SMS), multimedia messaging service (MMS), hypertext transfer protocol (HTTP), direct data connection, Wireless Application Protocol (WAP), email or any other suitable message transfer service or format.

Hardware

Referring back to FIG. 1, in one embodiment, the main system 10 includes a single server which implements the contribution system 12 and the scoring system 14. In another embodiment, the main system 10 includes multiple servers, one of which implements the contribution system 12 and the other of which implements the scoring system 14. In one embodiment, each of the one or more servers includes: (a) a processor (such as the processor 40 or 200) or a central processing unit (CPU); and (b) one or more data storage devices (such as data storage device 20, 194, 210 or 214), including, but not limited to, a hard drive with a spinning magnetic disk, a Solid-State Drive (SSD), a floppy disk, an optical disk (including, but not limited to, a CD or DVD), a Random Access Memory (RAM) device, a Read-Only Memory (ROM) device (including, but not limited to, programmable read-only memory (PROM), electrically erasable programmable read-only memory (EPROM), electrically erasable programmable read-only memory (EEPROM)), a magnetic card, an optical card, a flash memory device (including, but not limited to, a USB key with non-volatile memory, any type of media suitable for storing electronic instructions or any other suitable type of computer-readable storage medium.

In one embodiment, each of the one or more servers is a general purpose computer. In one embodiment, the one or more servers function to deliver webpages at the request of clients, such as web browsers, using the Hyper-Text Transfer Protocol (HTTP). In performing this function, the one or more servers deliver Hyper-Text Markup Language (HTML) documents and any additional content which may be included, or coupled to, such documents, including, but not limited, to images, style sheets and scripts.

The network access devices 42 and 202 can include any device operable to access the network 18, including, but not limited to, a personal computer (PC) (including, but not limited to, a desktop PC, a laptop or a tablet), smart television, Internet-enabled TV, person digital assistant, smartphone, cellular phone or mobile communication device. In one embodiment, each network access device 42 and 202 has at least one input device (including, but not limited to, a touchscreen, a keyboard, a microphone, a sound sensor or a speech recognition device) and at least one output device (including, but not limited to, a speaker, a display screen, a monitor or an LCD).

In one embodiment, the one or more servers and network access devices each include a suitable operating system. Depending upon the embodiment, the operating system can include Windows, Mac, OS X, Linux, Unix, Solaris or another suitable computer hardware and software management system. In one embodiment, each of the network access devices has a browser operable by the processors to retrieve, present and traverse the following: (a) information resources on the one or more servers of the system 10; and (b) information resources on the World Wide Web portion of the Internet.

Software

In one embodiment, the computer-readable instructions, algorithms and logic of the main system 10 (including the computer-readable instructions 26, conditions logic 24, score determination logic 183, computer-readable instructions 196, score determination logic 216, recommendation scoring algorithms 184, computer-readable instructions 212, score determination logic 216 and computer readable instructions 218) are implemented with any suitable programming or scripting language, including, but not limited to, C, C++, Java, COBOL, assembler, PERL, Visual Basic, SQL Stored Procedures or Extensible Markup Language (XML). The algorithms of main system 10 can be implemented with any suitable combination of data structures, objects, processes, routines or other programming elements.

In one embodiment, the data storage devices 20, 194, 210 and 214 of the system 10 hold or store web-related data and files, including, but not limited, to HTML documents, image files, Java applets, JavaScript, Active Server Pages (ASP), Common Gateway Interface scripts (CGI), XML, dynamic HTML, Cascading Style Sheets (CSS), helper applications and plug-ins.

In one embodiment, the interfaces of the main system 10 are Graphical User Interfaces (GUIs) structured based on a suitable programming language. The GUIs include, in one embodiment, windows, pull-down menus, buttons, scroll bars, iconic images, wizards, the mouse symbol or pointer, and other suitable graphical elements. In one embodiment, the GUIs incorporate multimedia, including, but not limited to, sound, voice, motion video and virtual reality interfaces.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method for incentivizing contribution of information, the method comprising:
operating at least one processor in accordance with a plurality of computer-readable instructions, the at least one processor performing a plurality of steps including:
(a) receiving information from a user, the received information being related to one of a plurality of different marketed offerings;
(b) determining whether the received information satisfies a point-earning condition;
(c) establishing a point balance for the user in response to the received information satisfying the point-earning condition;
(d) determining whether the point balance satisfies an award condition; and
(e) allocating an award to the user in response to the point balance satisfying the award condition.

2. The method of claim 1, wherein the received information includes a grade selected from a scale of grades.

3. The method of claim 1, wherein the received information includes at least one grade and at least one text entry.

4. The method of claim 1, wherein the step of determining whether the received information satisfies the point-earning condition, includes processing data associated with a point-earning table, the point-earning table specifying different amounts of points associated with a set of point-earning conditions including the point-earning condition, wherein the set of point-earning conditions includes a plurality of different factors, the factors including: (a) whether the received information reveals the user's identity; (b) whether the received information includes a comment in addition to a recommendation grade; (c) whether the user validates the received information by submitting evidence; and (d) whether the user receives a positive mark related to the received information, the positive mark being provided by another user.

5. The method of claim 1, wherein the step of determining whether the point balance satisfies an award condition, includes processing data associated with an award table, the award table specifying different awards corresponding to a set of award conditions including the award condition, wherein the set of award conditions includes a plurality of different factors, the factors including: (a) whether the point balance reaches a designated level within a designated time period; (b) whether a designated point balance related to a marketed offering category reaches a designated level within a designated time period; (c) whether the user is a first of a plurality of other users to reach a designated point balance level across a plurality of marketed offering categories; (d) whether the user is a first of the other users to reach a designated point balance level for one of the marketed offering categories; and (e) whether the user is a first of the other users to reach a highest point balance related to a marketed offering category within a designated time period.

6. The method of claim 1, wherein the steps include receiving a mark from another user, the mark being one of a positive mark or a negative mark.

7. The method of claim 6, wherein the steps include changing a credential level associated with the user, the change depending, at least in part, on whether the received mark is a positive mark or a negative mark.

8. The method of claim 1, wherein the steps include causing at least one display device to display the received information without indicating an identity of the user.

9. A system comprising:
at least one data storage device accessible by at least one processor, the at least one data storage device storing:
(a) data associated with:
(i) a plurality of different marketed offerings;
(ii) at least one point-earning condition;
(iii) at least one award condition; and
(iv) at least one award associated with the at least one award condition; and
(b) a plurality of instructions which, when read by the at least one processor, cause the at least one processor to:
(i) receive information from a user related to at least one of the marketed offerings;
(ii) determine whether the received information satisfies the at least one point-earning condition;
(iii) establish a point balance for the user in response to the received information satisfying the at least one point-earning condition;
(iv) determine whether the point balance satisfies the at least one award condition; and
(v) allocate the at least one award to the user in response to the point balance satisfying the at least one award condition.

10. The system of claim 9, wherein the received information includes a grade selected from a scale of grades.

11. The system of claim 9, wherein the received information includes at least one grade and at least one text entry.

12. The system of claim 9, wherein the at least one data storage device stores data associated with a point-earning table, the point-earning table specifying different amounts of points associated with a plurality of different point-earning conditions, the point-earning conditions including a plurality of different factors, the factors including: (a) whether the received information reveals the user's identity; (b) whether the received information includes a comment in addition to a recommendation grade; (c) whether the user validates the received information by submitting evidence; and (d) whether the user receives a positive mark related to the received information, the positive mark being provided by another user.

13. The system of claim 9, wherein the at least one data storage device stores data associated with an award table, the award table specifying different awards corresponding to a plurality of the award conditions, the award conditions including a plurality of different factors, the factors including: (a) whether the point balance reaches a designated level within a designated time period; (b) whether a designated point balance related to a marketed offering category reaches a designated level within a designated time period; (c) whether the user is a first of a plurality of other users to reach a designated point balance level across a plurality of marketed offering categories; (d) whether the user is a first of the other users to reach a designated point balance level for one of the marketed offering categories; and (e) whether the user is a first of the other users to reach a highest point balance related to a marketed offering category within a designated time period.

14. The system of claim 9, wherein the at least one data storage device stores a plurality of instructions which, when read by the at least one processor, cause the at least one processor to operate with at least one input device to receive a mark from another user, the mark being one of a positive mark or a negative mark.

15. The system of claim 14, wherein the at least one data storage device stores a plurality of instructions which, when read by the at least one processor, cause the at least one processor to operate with at least one input device to change a credential level associated with the user, the change depending, at least in part, on whether the received mark is a positive mark or a negative mark.

16. The system of claim 9, wherein the at least one data storage device stores a plurality of instructions which, when read by the at least one processor, cause the at least one processor to operate with at least one display device to display the received information in association with the marketed offerings, the displayed information concealing an identity of the user.

17. A system comprising:
at least one data storage device accessible by at least one processor, the at least one data storage device storing:
(a) data associated with:
(i) a plurality of different marketed offerings;
(ii) a plurality of point-earning conditions;
(iii) a plurality of award conditions; and
(iv) a plurality of awards, each one of the awards being associated with one of the award conditions; and
(b) a plurality of instructions which, when read by the at least one processor, cause the at least one processor to operate with at least one display device and at least one input device to:
(i) establish an account for a user;
(ii) establish a point balance for the user;
(iii) display a plurality of marketed offering symbols, each one of the marketed offering symbols being associated with one of the marketed offerings;
(iv) receive a selection from the user, the selection being associated with one of the marketed offerings;
(v) receive information contributed by the user, the contributed information being associated with the selection;
(vi) determine whether one of the point-earning conditions is satisfied as a result of the user's contribution of the information;
(vii) update the point balance depending upon the determination;
(viii) determine whether the updated point balance satisfies one of the award conditions; and
(ix) allocate one of the awards to the account in response to the updated point balance satisfying one of the award conditions.

18. The system of claim 17, wherein at least one of the instructions, when read by the at least one processor, causes the at least one processor to operate with the at least one input device to repeat steps (b)(iv) through (b)(ix) for another one of the marketed offerings.

19. The system of claim 17, wherein the contributed information includes at least one grade and at least one text entry.

20. The system of claim 17, wherein the at least one data storage device stores data associated with a point-earning table, the point-earning table specifying different amounts of points associated with the plurality of different point-earning conditions, the point-earning conditions including a plurality of different factors, the factors including: (a) whether the contributed information reveals the user's identity; (b) whether the contributed information includes a comment in addition to a recommendation grade; (c) whether the user validates the contributed information by submitting evidence; and (d) whether the user receives a positive mark related to the contributed information, the positive mark being provided by another user.

21. The system of claim 17, wherein the at least one data storage device stores data associated with an award table, the award table specifying different awards corresponding to the plurality of award conditions, the award conditions including a plurality of different factors, the factors including: (a) whether the point balance reaches a designated level within a designated time period; (b) whether a designated point balance related to a marketed offering category reaches a designated level within a designated time period; (c) whether the user is a first of a plurality of other users to reach a designated point balance level across a plurality of marketed offering categories; (d) whether the user is a first of the other users to reach a designated point balance level for one of the marketed offering categories; and (e) whether the user is a first of the other users to reach a highest point balance related to a marketed offering category within a designated time period.

22. The system of claim 17, wherein the at least one data storage device stores a plurality of instructions which, when read by the at least one processor, cause the at least one processor to operate with at least one input device to receive a mark from another user, the mark being one of a positive mark or a negative mark.

23. The system of claim 22, wherein the at least one data storage device stores a plurality of instructions which, when read by the at least one processor, cause the at least one processor to operate with at least one input device to change a credential level associated with the user, the change depending, at least in part, on whether the received mark is a positive mark or a negative mark.
